(19) United States
(12) Patent Application Publication
(10) Pub. No.: US 2012/0111435 A1
(43) Pub. Date: May 10, 2012

(54) FLUID-DIRECTING MULTIPORT ROTARY APPARATUS

(75) Inventor: Michael ANTONETTI, Burgettstown, PA (US)

(73) Assignee: CALGON CARBON CORPORATION, Pittsburgh, PA (US)

(21) Appl. No.: 13/252,786

(22) Filed: Oct. 4, 2011

Related U.S. Application Data
(60) Provisional application No. 61/389,510, filed on Oct. 4, 2010.

(51) Int. Cl. F16K 11/00

(52) U.S. Cl. 137/625; 137/597

(57) ABSTRACT

Multiport rotary fluid-directing apparatuses are disclosed. An apparatus includes first and second stationary heads, first and second rotating heads, media vessels and a rotating system. The first stationary head has first ports configured to receive fluid from a fluid source and second ports configured to pass fluid to a media vessel. Each of the first and second rotating heads has multiple first and second ports and channels that fluidly connect corresponding first and second ports of the corresponding rotating head. The second stationary head has first ports configured to pass fluid to an output and second ports configured to receive fluid from a media vessel. The media vessels are configured to receive fluid from a second port of a first stationary head and transmit fluid to a corresponding second port of a second stationary head. The rotating system is configured to cause the first and second rotating heads to rotate.

### CLAIM OF PRIORITY TO RELATED APPLICATIONS

This application claims priority to U.S. Provisional Application Ser. No. 61/389,510 entitled “Fluid-Directing Multiport Rotary Apparatus” and filed Oct. 4, 2010, which is incorporated herein by reference in its entirety.

Not Applicable

### BACKGROUND

The present disclosure generally relates to a multiport rotary apparatus for directing multiple fluid streams. In particular, the present disclosure relates to an improved multiport rotary apparatus for simultaneously directing a plurality of fluid streams into and out of a fluid-solid contacting apparatus employed for treatment of a multi-component fluid mixture for purification, recovery, separation and synthesis.

Multiport rotary valves with turntables have been used for many years in continuous ion exchange and chromatographic separation applications. However, some users desired designs that imposed different space requirements and/or required fewer moving parts in order to achieve the ion exchange process.

Turntableless designs were developed to overcome the necessity of moving the fluid containers with which they were associated. In a turntableless design, the input and output streams are changed from process step to process step while the fluid containers remain stationary. Resulting turntableless designs do not require the additional mechanical moving parts associated with turntable designs and are not hampered by the stringent space requirements of turntable designs.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The present invention provides a combined multi-port rotary valve for simultaneously directing a plurality of fluid streams sequentially into or out of a plurality of stationary fluid-solid contacting chambers employed for purifying and separating multi-component fluids while eliminating many of the disadvantages in the art. Less complex processes like SMB chromatography may employ one single multi port valve, but in practice, it is preferred to have two multiport rotary valves joined into one combined multiport rotary valve apparatus. While two valves can be configured physically independent of each other, they must rotate or index in synchronization with one another, which makes it preferable to integrate them together as a combined multiport rotary valve. It is also preferred to have more than two contacting chambers, for example.

It is an aspect of the present invention to provide a combined multiport rotary valve that eliminates rotating fluid-solid chambers on a turntable, which addresses the mechanical complexity, layout limitations and safety issues of a turntable in the prior art.

It is another aspect of the present invention to provide a combined multiport rotary valve that has the same configuration design in any process and many symmetrical components which allows for simplified inventory of multiport rotary valve parts and addresses the disadvantage of the process specific design of prior art.

It is still another aspect of the present invention to provide a combined multiport rotary valve with only two planar sealing surfaces, which eliminates the complex circular channel and annular sealing technology employed in prior art.

Another aspect of the present invention is to provide a simplified and accessible design that allows for visual inspection of a majority of the parts.

In an embodiment, a multiport rotary fluid-directing apparatus may include a first stationary head having a plurality of first ports and a plurality of second ports, wherein each first port of the first stationary head is configured to receive fluid from a fluid source, wherein each second port of the first stationary head is configured to pass fluid to a media vessel, a first rotating head having a plurality of first ports, a plurality of second ports and a plurality of channels, wherein each channel of the first rotating head fluidly connects a first port of the first rotating head to a corresponding second port of the first rotating head, a second rotating head having a plurality of first ports, a plurality of second ports and a plurality of channels, wherein each channel of the second rotating head fluidly connects a first port of the second rotating head to a corresponding second port of the second rotating head, a second stationary head having a plurality of first ports and a plurality of second ports, wherein each first port of the second stationary head is configured to pass fluid to an output, wherein each second port of the second stationary head is configured to receive fluid from a media vessel, a plurality of media vessels configured to receive fluid from a second port of a first stationary head and transmit fluid to a corresponding second port of a second stationary head, and a rotating system configured to cause the first rotating head and the second rotating head to rotate, wherein the rotating system comprises a motor and a controller.

### BRIEF DESCRIPTION OF THE DRAWINGS

FIG. 1 is a schematic drawing of a combined multiport rotary valve being used as a continuous contacting apparatus for fluid purification.

FIG. 2 is an exploded perspective of a combined multiport rotary valve in accordance with invention.

FIG. 2b is a continuation of the exploded perspective of a combined multiport rotary valve in accordance with invention.

FIG. 3 is an exploded cross sectional view of the combined multiport rotary valve from FIG. 2.

FIG. 4 is a top plan view of top end cap 210 of FIG. 3.

FIG. 5 is a side view of top end cap 210 of FIG. 3.

FIG. 6 is a top plan view of the pressure plate 220 of FIG. 3.

FIG. 7 is a side view of the pressure plate 220 of FIG. 3.

FIG. 8 is a bottom plan view of the pressure plate 220 of FIG. 3.

FIG. 9 is a top plan view of the top stationary head 230 of FIG. 3.

FIG. 10 is a side view of the top stationary head 230 of FIG. 3.

FIG. 11 is a bottom plan view of the top stationary head 230 of FIG. 3.

FIG. 12 is a top plan view of the top rotating head 240 of FIG. 3.

FIG. 13 is a side view of the top rotating head 240 of FIG. 3.

FIG. 14 is a bottom plan view of the top rotating head 240 of FIG. 3.

FIG. 15 is a top plan view of the sprocket gear 250 of FIG. 3.

FIG. 16 is a side view of the sprocket gear 250 of FIG. 3.

FIG. 17 is a bottom plan view of the sprocket gear 250 of FIG. 3.

FIG. 18 is a top plan view of the bottom rotating head 260 of FIG. 3.

FIG. 19 is a side view of the bottom rotating head 260 of FIG. 3.

FIG. 20 is a bottom plan view of the bottom rotating head 260 of FIG. 3.

FIG. 21 is a top plan view of the bottom stationary head 270 of FIG. 3.

FIG. 22 is a side view of the bottom stationary head 270 of FIG. 3.

FIG. 23 is a bottom plan view of the bottom stationary head 270 of FIG. 3.

FIG. 24 is a top plan view of bottom end cap 280 of FIG. 3.

FIG. 25 is a side view of bottom end cap 280 of FIG. 3.

FIG. 26 is a side view of the multiport rotary valve stand 290 of FIG. 3.

FIG. 27 is a bottom plan view of stationary head 230 of FIG. 11 with simplified overlay of rotating head internal transverse conduits 238 from FIG. 12 before one index.

FIG. 28 is a bottom plan view of stationary head 230 of FIG. 11 with simplified overlay, of rotating head internal transverse conduits 238 from FIG. 12 after one index.

FIG. 29 is a perspective view of an alternative stand, housing and drive of multiport rotary valve 200 from FIG. 3.

FIGS. 30A-D depict a graphical representation of an exemplary 20-port valve as it is rotated through a plurality of positions according to an embodiment.

FIG. 31 depicts an exploded view of an exemplary 30-port rotating head assembly according to an embodiment.

FIG. 32 depicts an exemplary multiport apparatus for directing fluid according to an embodiment.

FIG. 33 depicts a block diagram of exemplary internal hardware that may be used to contain or implement program instructions according to an embodiment.

### DETAILED DESCRIPTION

The following terms shall have, for the purposes of this application, the respective meanings set forth below.

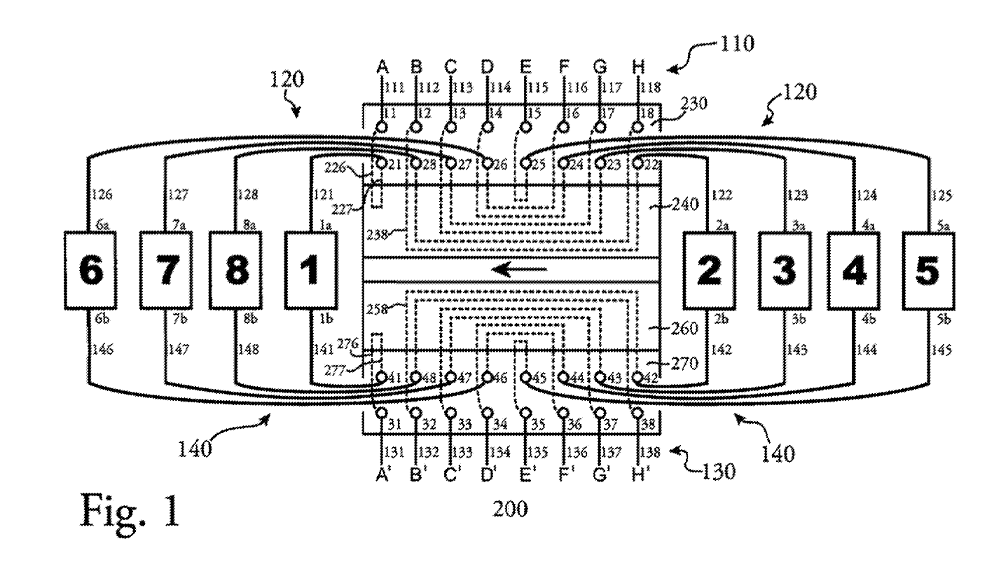

Referring to FIG. 1, invention 200 is shown in a schematic with a plurality of fluid contacting chambers 1-8. Chambers 1-8 have a first connection 1a-8a that connects by conduits 120 to multiport valve 200 at ports labeled 21-28. The same chambers 1-8 have a second connection 1b-8b that connect by conduits 140 to multiport valve 200 at ports labeled 41-48. Process streams A-H connect by conduits 110 with multiport valve 200 through ports 11-18 and are in connection with chamber connections 21-28 by internal conduits 226, 238 and 227. Process streams A′-H′ connect by conduits 130 to the same multiport valve 200 through ports 31-38 and are in connection with chamber connections 41-48 by internal conduits 276, 258 and 277. For the sake of clarity, labels 226 and 227 refer to all similar internal conduits on stationary head 230 while labels 276 and 277 refer to all similar internal conduits on stationary head 270. Labels 238 and 258 refer to all internal transverse channels in rotating heads 240 and 260 respectively and are rotatable in relation to the process connections 11-18, 31-38 and the chamber connections 21-28, 41-48 thereby allowing a simulated movement of chambers 1-8 to the process streams A-H and A′-H′. Note that the number of contacting chambers is merely an example and the actual number of chambers utilized can be of any number greater than two. Correspondingly, the number of inlets, outlets, conduits, ports and so on would be adjusted accordingly.

The present embodiment of the combined multiport rotary valve 200 of the invention is shown and described in conjunction with fluid solid contacting chambers containing a treatment media wherein a contaminated feed stream is continually treated by the media while at the same time the exhausted media is continually regenerated and put back into service. Using water softening ion exchange as an example, each chamber will contain the same typical strong acid cation resin. The four required steps in a water softening application are described as “Service”, “Backwash”, “Chemical” and “Rinse”. “Service” is the treatment of the incoming water with the cation resin until the resin capacity is exhausted, “Backwash” is the removal of particulates from the resin, “Chemical” is the process of reverse ion exchange where salt is used to put the resin back into a usable form, “Rinse” is the process of removing excess salt from and around the resin prior to placing it back into “Service”. In a batch operation like a domestic water softener these four steps are preformed sequentially after the batch system is taken out of operation. In a continuous system like the one described here all four steps occur at the same time since at least one chamber is in each step at each instant, allowing for continuous operation. In the water softening example with this invention, streams A-E will be the incoming contaminated or hard water and are in “Service” and are being treated by the resin in chambers 1-5. Water for treatment would enter stationary head 230 of multiport rotary valve 200 by conduit 111-115 at port connections 11-15. Streams A-E proceed by internal conduits 226 to rotary head 240 and are redirected by internal transverse conduits 238 back to stationary head 230 and by internal conduits 227 to chamber connections 21-25. Streams A-E then proceed by conduits 121-125 to enter chambers 1-5 through connections 1a-5a. Streams A-E contact the strong acid cation resin contained in chambers 1-5 and exchange hard ions in solution like calcium and magnesium for the soft ion sodium on the resin. The calcium and magnesium are captured by the strong acid cation resin while an equivalent number of sodium ions are exchanged into the streams. Hard water streams A-E now become soft or treated water streams A′-E′ and exit chambers 1-5 through connections 1b-5b and connect by conduits 141-145 to the stationary head 270 at ports 41-45. Streams A′-E′ proceed by internal conduits 277 to rotating head 260 and are redirected by internal transverse conduits 258 back to the stationary head 270. Streams A′-E′ now proceed by internal conduits 276 and exit at ports 31-35 to conduits 131-135 as treated soft water. Continuing with the softening example the other streams in total are generally called “regeneration” and include streams F, G, H, F′, G′ and H′. The steps will be described in reverse order since the resin in the chambers will move counter-currently to the streams. Stream H′ by conduit 138 directs untreated water into multiport valve 200 at port 38 in stationary head 270. Stream H′ proceeds by an internal conduit 276 to rotating head 260 and is redirected by an internal transverse conduit 258 back to stationary head 270 and proceeds by an internal conduit 277 to exit at port 48. Stream H′ proceeds by conduit 148 to chamber 8 through connection 8b. Stream H′ proceeds in an upward direction through the resin contained in chamber 8 and serves as a backwash stream to remove any entrained particulates or broken resin beads and proceeds out of chamber 8 through connection 8a as stream H. Stream H proceeds by conduit 128 to stationary head 230 of multiport valve 200 through connection 28 and proceeds by an internal conduit 227 to rotary head 240 and is redirected by an internal transverse conduit 238 back to stationary head 230. Stream H proceeds by an internal conduit 226 to exit multiport valve 200 through port 18 where Backwash waste stream H is directed to waste by conduit 118. Stream G is the “Chemical” step and directs a salt (NaCl) solution by conduit 117 into multiport valve 200 through port 17 in stationary head 230. Stream G proceeds by an internal conduit 226 to rotating head 240 and is redirected by an internal transverse conduit 238 back to stationary head 230 and proceeds by an internal conduit 227 to exit through port 27. Salt stream G then proceeds by conduit 127 to chamber 7 through connection 7a. Stream G proceeds in a downward direction through the resin contained in chamber 7 and serves as a regeneration stream to exchange soft monovalent ions (Na+) in solution for hard divalent ions (Ca++ and Mg++) captured on the resin. The strong acid cation resin generally prefers divalent ions over monovalent ions in low concentrations as in the untreated water. However, a high concentration of monovalent sodium ions in the salt stream will overwhelm and displace the divalent ions and put the resin back in the monovalent sodium form and is called regeneration. Stream G proceeds out of chamber 7 through connection 7b as stream G′. Stream G′ proceeds by conduit 147 to stationary head 270 of multiport valve 200 through port 47 and proceeds by an internal conduit 277 to rotary head 260 and is redirected by an internal transverse conduit 258 back to stationary head 270. Stream G′ then proceeds by an internal conduit 276 to exit multiport valve at port 37 as regeneration waste stream G′ which is directed to waste by conduit 137. Stream F is water used for rinse and proceeds by conduit 116 to enter multiport valve 200 through port 16 in stationary head 230 and proceeds by an internal conduit 226 to rotating head 240 and is redirected by an internal transverse conduit 238 back to stationary head 230. Stream F then proceeds by an internal conduit 227 to exit through port 26 and proceed by conduit 126 to chamber 6 through connection 6a. Stream F proceeds in a downward direction through the resin contained in chamber 6 and serves as a rinse stream to displace the excess NaCl in the chamber. Stream F proceeds out of chamber 6 through connection 6b as stream F′ and connects by conduit 146 to stationary head 270 of multiport valve 200 at port 46. Stream F proceeds by an internal conduit 277 to rotary head 260 and is redirected by an internal transverse conduit 258 back to stationary head 270 and proceeds by an internal conduit 276 to exit the multiport valve through port 36 as rinse waste stream F′, which is directed to waste by conduit 136.

The rotating heads 240 and 260 of multiport rotary valve 200 remain in the same position and maintain the current flow path by internal transverse conduits 238 and 258 until an end point time when substantially all monovalent sodium ions on the strong acid cation resin in chamber 1 have been exchanged for divalent ions calcium and magnesium in Stream A. This end point time can be determined empirically by sensor, or estimated by time based on resin capacity, feed service flow rate and ion load in the feed. When the end point is reached and capacity for divalent ions in chamber 1 is exhausted, the rotating heads 240 and 260 are indexed clockwise, looking from top down, one position. This index essentially moves by internal transverse conduits 238 and 258, chamber 1 from “Service” and places it into the first regeneration step called “Backwash” which chamber 8 previously held. At this same time, chambers 2-8 also move one position in the sequence so that chamber 2 is now in the lead “Service” position which chamber 1 previously held, chambers 3-5 moved one position, but remain in “Service”, chamber 6 is brought into the last “Service” position which chamber 5 previously held, chamber 7 is moved into a “Rinse” position that chamber 6 previously held and chamber 8 moves to the “Chemical” position that chamber 7 previously held. In this way, the resin in each chamber is being moved counter-currently to the incoming streams. As the resin is exhausted it is moved out of the service cycle, into the regeneration cycle and back finally back into “Service” by successive indexing of the rotating heads.

After one index of the rotating heads 240 and 260 as described in the previous paragraph, the flow paths are modified as follows:

Streams A-E continue as incoming hard water for treatment and are in “Service” and enter the stationary head 230 of multiport rotary valve 200 by conduits 111-115 at port connections 11-15. Streams A-E proceed by internal conduits 226 to rotary head 240 and are redirected by internal transverse conduits 238 back to stationary head 230 and by internal conduits 227 to chamber ports 22-26. Streams A-E then proceed by conduit 122-126 to enter chambers 2-6 through connections 2a-6a. Hard water streams A-E contact the strong acid cation resin contained in chambers 2-6 become soft or treated water streams A′-E′ and exit chambers 2-6 through connections 2b-6b and connect by conduits 142-146 to the stationary head 270 at ports 42-46. Streams A′-E′ proceed by internal conduits 277 to rotating head 260 and are redirected by internal transverse conduits 258 back to the stationary head 270. Streams A′-E′ now proceed by internal conduits 276 and exit at ports 32-36 to conduits 132-136 as treated soft water.

Stream H′ by conduit 138 directs untreated water into multiport valve 200 at port 38 in stationary head 270. Stream H′ proceeds by an internal conduit 276 to rotating head 260 and is redirected by an internal transverse conduit 258 back to stationary head 270 and proceeds by an internal conduit 277 to exit at port 41. Stream H′ proceeds by conduit 141 to chamber 1 through connection 1b. Stream H′ proceeds in an upward direction through the resin contained in chamber 1 and proceeds out of chamber 1 through connection la as stream H. Stream H proceeds by conduit 121 to stationary head 230 of multiport valve 200 through port 21 and proceeds by an internal conduit 227 to rotary head 240 and is redirected by an internal transverse conduit 238 back to stationary head 230. Stream H proceeds by an internal conduit 226 to exit multiport valve 200 through port 18 where Backwash waste stream H is directed to waste by conduit 118.

Stream G directs a salt (NaCl) solution by conduit 117 into multiport valve 200 through port 17 in stationary head 230. Stream G proceeds by an internal conduit 226 to rotating head 240 and is redirected by an internal transverse conduit 238 back to stationary head 230 and proceeds by an internal conduit 227 to exit through port 28. Stream G then proceeds by conduit 128 to chamber 8 through connection 8a. Stream G proceeds in an downward direction through the resin contained in chamber 8 and proceeds out of chamber 8 through connection 8b as stream G′. Stream G′ proceeds by conduit 148 to stationary head 270 of multiport valve 200 through port 48 and proceeds by an internal conduit 277 to rotary head 260 and is redirected by an internal transverse conduit 258 back to stationary head 270. Stream G′ then proceeds by an internal conduit 276 to exit the multiport valve at port 37 as regeneration waste stream G′ which is directed to waste by conduit 137.

Stream F is treated water used for rinse and proceeds by conduit 116 to enter multiport valve 200 through port 16 in stationary head 230 and proceeds by an internal conduit 226 to rotating head 240 and is redirected by an internal transverse conduit 238 back to stationary head 230. Stream F then proceeds by an internal conduit 227 to exit through port 27 and proceed by conduit 127 to chamber 7 through connection 7a. Stream F proceeds in a downward direction through the resin contained in chamber 7 and proceeds out of chamber 7 through connection 7b as stream F′ and connects by conduit 147 to stationary head 270 of multiport valve 200 at port 47. Stream F proceeds by an internal conduit 277 to rotary head 260 and is redirected by an internal transverse conduit 258 back to stationary head 270 and proceeds by an internal conduit 276 to exit multiport valve through port 36 as rinse waste stream F′, which is directed to waste by conduit 136.

The rotating heads 240 and 260 of multiport rotary valve 200 remain in the same position and maintain the current flow path by internal transverse conduits 238 and 258 until an end point time. When the end point is reached and capacity for divalent ions in chamber 2 is exhausted, the rotating heads 240 and 260 are again indexed clockwise one position. This index essentially moves by internal transverse conduits 238 and 258, chamber 2 from “Service” and places it into the first regeneration step called “Backwash” which chamber 1 previously held. The remaining chambers also move one position in the sequence. At every index, the chambers essentially move one position forward in the sequence and complete a full cycle 2× in every 360-degree rotation of the rotating heads 240 and 260. In this manner, the use of a turntable in the prior art has been eliminated.

According to the present embodiment, the invention 200 retains complete flexibility in assigning the inlet and outlet ports 11-18 and 31-38 to any desired fluid stream and direction and combination therefore eliminating the fixed configuration issues with prior art valves. Treatment of fluid streams, gas or liquid, in the fluid solid contacting apparatus chambers could, for example, be accomplished by any such media, chemical reactant or physical process like ion exchange, chromatography, adsorption, reaction, catalysis, filtration or heat exchange and is solely determined by the media choice and by fixed conduits exterior to the multiport rotary valve and not by the valve itself, such that multiport rotary valve 200 provides an efficient and continuous means of contacting the media or reactant in the chamber with the various fluid streams.

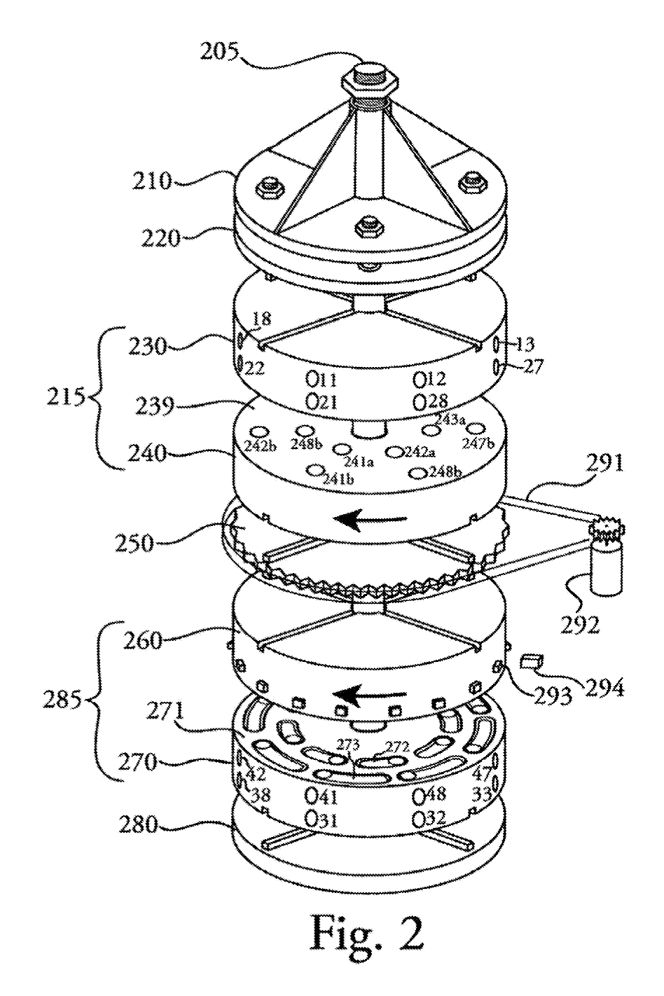

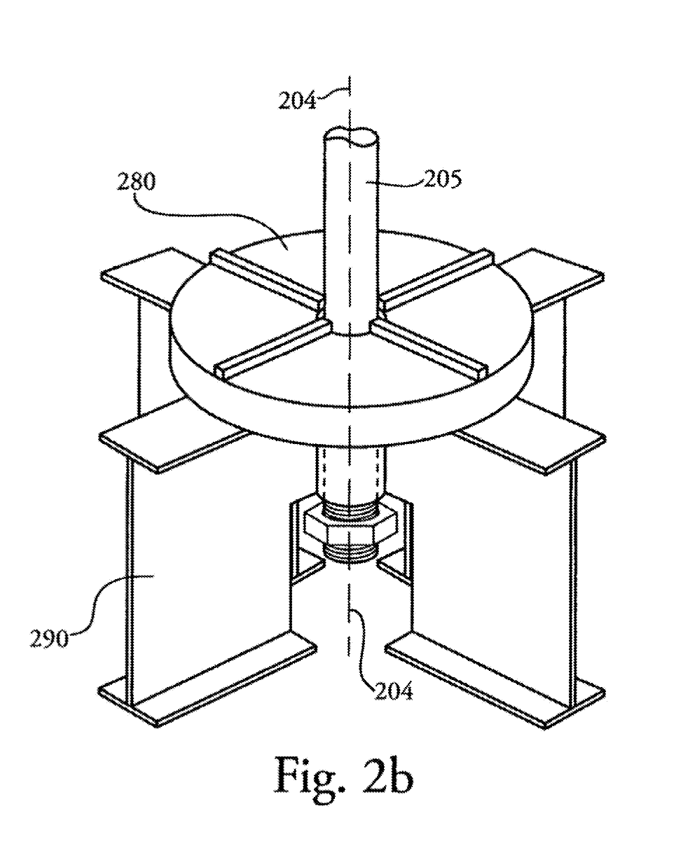

FIG. 2 shows an exploded perspective of the combined multiport rotary valve of the present invention. Rotary valve 200 comprises two major assemblies, upper multiport rotary valve 215 and lower multiport rotary valve 285; all are of circular shape having substantially equal diameter and each having opposed planar sealing surfaces. The present embodiment of this invention utilizes a keyed and threaded central shaft 205 for assembling the entire rotary valve apparatus and for providing a mechanical means to force a seal of the stationary head 230 to the rotating head 240 and rotating head 260 to stationary head 270. Other means to force the seal of the stationary and rotating heads by means like pneumatic bladder or hydraulic cylinder in combination with internal seals would also be suitable.

The stationary head assemblies 230, 270 are held fixed from rotating by pressure plate 220 and end cap 280 and are forced against the rotating head assemblies 240, 260 by mechanical means from pressure plate 220 while constrained by central shaft 205, nut 202 and end cap 210 and stand 290 from FIG. 2b.

Top stationary head 230 has ports 11-18 for the connection of process inlets and outlets and ports 21-28 for one connection to each fluid solid contacting chamber and has internal conduits in the head for the communication of these ports to a planar face in sealing contact with the top rotating head 240.

Top rotating head 240 is in sealing contact with top stationary head 230 and accepts all fluid flows from top stationary head 230 through holes 241a-248a and 241b-248b and redirects the flows by internal transverse conduits connecting these holes back to the same top stationary head 230.

Sprocket gear 250 is provided for the purpose of moving the two rotating heads 240, 260 by means of external drive motor 292 and drive chain 291.

Bottom rotating head 260 is in sealing contact with bottom stationary head 270 and accepts all fluid flows from the bottom stationary head 270 and redirects the flows by internal transverse conduits back to the same bottom stationary head 270. Rotating head 260 has proximity targets 293 for position indication by proximity sensor 294 to properly align the rotating heads 240, 260 with their respective stationary heads 230, 270.

Bottom stationary head 270 has ports 31-38 for the connection of process inlets and outlets and ports 41-48 for one connection to each fluid solid contacting chambers 1-8 and internal conduits in the head for the communication of these ports to recessed arcuate obround windows 272 and 273 on a planar face in sealing contact with the bottom rotating head 270.

Bottom end cap 280 provides an opposing surface for the assembly and urging of the heads 230, 240, 250, 260 and 270 together.

A drive chain 291 and drive motor 292 indexes the rotating heads upon a signal from a control device (not shown, well known in the art) like a total flow indicator, timer, PLC, DCS or PC system programmed to initiate an index at a selected end point. The drive motor 292 and chain 291 drive the sprocket gear 250 which moves the rotating heads 240, 260 clockwise from a top vantage point until the next target 293 activates the proximity sensor which in turn stops rotation. The drive motor, chain and sprocket gear could be replaced with any such suitable method for moving or indexing the rotating heads like drive shaft, direct gear contact, drive belt or ratchet arrangement.

Stationary heads 230, 270 are preferably made of a polymeric material or composite material that is strongly resistant to abrasion and chemically compatible with the components of the fluid mixture. Rotating heads 240, 260 are preferably made of a machinable metal or of a machinable metal face in conjunction with composite polymeric disks that are all compatible with the components of the fluid mixture to be separated. Alternatively, stationary heads 230, 270 may be made of a machinable metal while the rotating heads may be made of a machinable polymeric or composite all of which are compatible with the components of the fluid mixture to be separated. To simplify construction, the stationary or rotating heads can be made from multiple plates or disks so that the internal conduits are easily routed into the plates and attached or fastened together into a composite head assembly. The rotating and stationary heads are made from materials that are compatible with the components of the fluid mixture to be separated and may be ceramics, composites, polymeric materials, metals, metal alloys and high-performance alloys.

Valve 200 provides for two rotating heads 240, 260 and two stationary heads 230, 270 with only one planar sealing surface between each valve assembly 215, 285 which greatly simplifies the sealing complexities of prior art turntable-less valve designs.

FIG. 2b shows the multiport rotary valve stand 290 supports the bottom end cap 280 and valve apparatus 200 and fixes the central shaft 205 at the vertical axis 204. Bottom end cap 280 can be fixed by any suitable method to the stand 290.

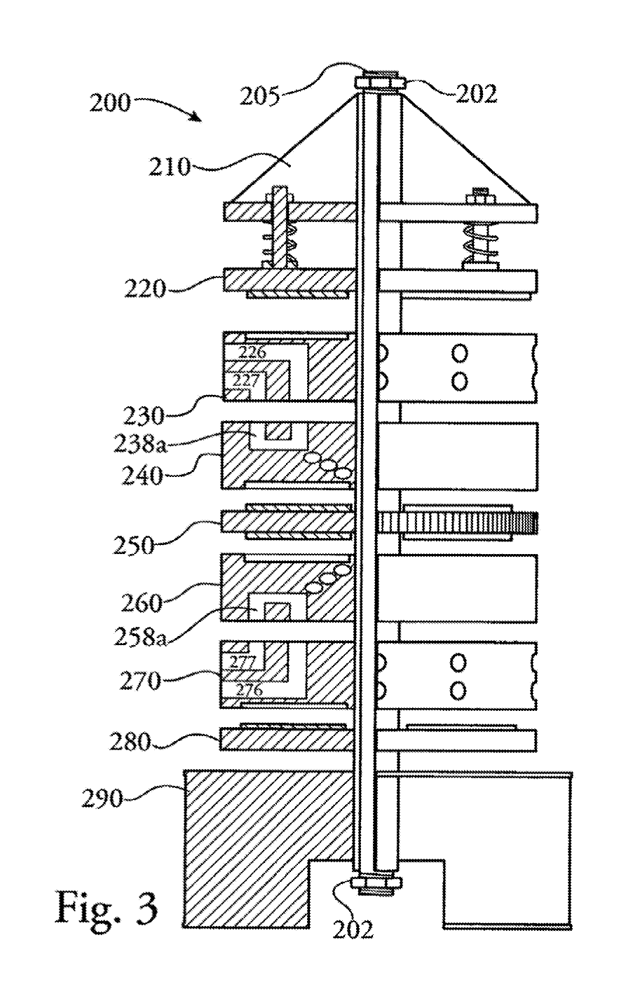

FIG. 3 shows an exploded cross sectional view of multiport rotary valve 200 from FIG. 2 and clearly shows a flow path by one internal conduit 226 from the top stationary head 230 through the internal transverse conduit 238a of the top rotating head 240 redirected back to one internal conduit 227 of the top stationary head 230. Similarly, one internal conduit flow path 276 in the bottom stationary head 270 enters internal transverse conduit 258a in the bottom rotating head 260 and is redirected back to one internal conduit 277 of the bottom stationary head 270. The cross sectional view shows the internal conduits of the stationary heads and rotating heads connect at their respective planar sealing faces. It further shows as an example, the shortest internal transverse conduit length in the rotating heads 240 and 260. For clarity, only one set of internal conduits in is shown in this drawing.

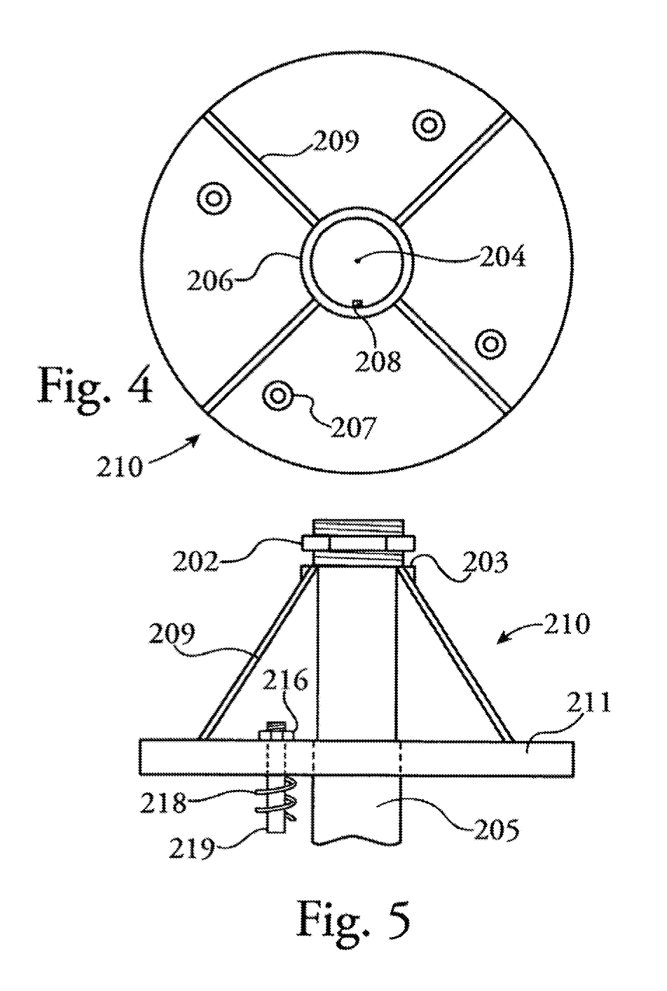

FIG. 4 and FIG. 5 show top planar and side views of the top end cap 210 preferably made of metal. Gussets 209 substantially strengthen the end plate 211 and locate the shaft tube 206 central to the end plate. The end cap 210 is held fixed from turning by key 208 which mates with the slotted central shaft 205, FIG. 2. The end plate has holes 207 for threaded rods 219 and nuts 216 which constrain the springs 218. While valve 200 uses a mechanically simple method of sealing force by a plurality of springs 218, alternate means of providing a sealing force like hydraulic piston, pneumatic piston or Belleville washers are possible. The internal diameter of 206 is slightly larger than the threaded shaft 205 and essentially limits sideways movement of shaft 205 while surface 203 provides a flat for nut 202 to limit vertical movement of end cap 210.

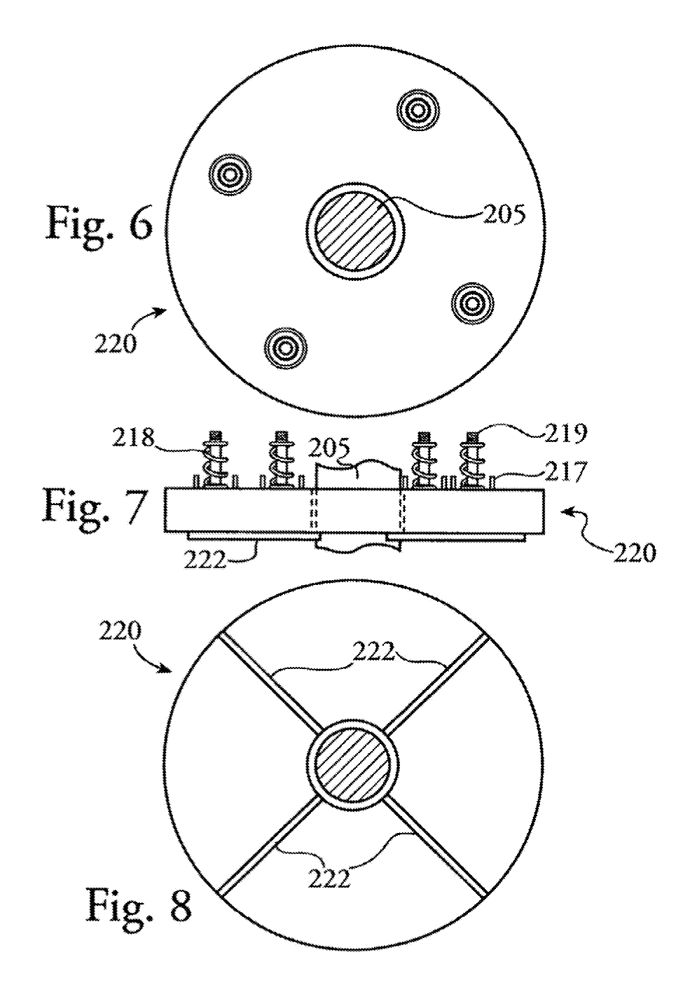

FIGS. 6, 7 and 8 show side and planar views of pressure plate 220 preferably made of metal and centrally located around shaft 205. FIGS. 6 and 7 show, for example, four threaded rods 219, each with an associated spring 218 and end stop 217. The number and force of the springs are designed to provide adequate sealing pressure for the planar sealing faces of the stationary heads 230, 270 and rotating heads 240, 260 as shown in FIG. 3. FIG. 8 shows four, for example, keys 222 for the horizontal aligning and keeping of the top stationary head 230 of FIG. 3. These keys will prevent rotation of stationary head 230, but allow for some vertical movement necessary for planar sealing with rotating head 240 of FIG. 3.

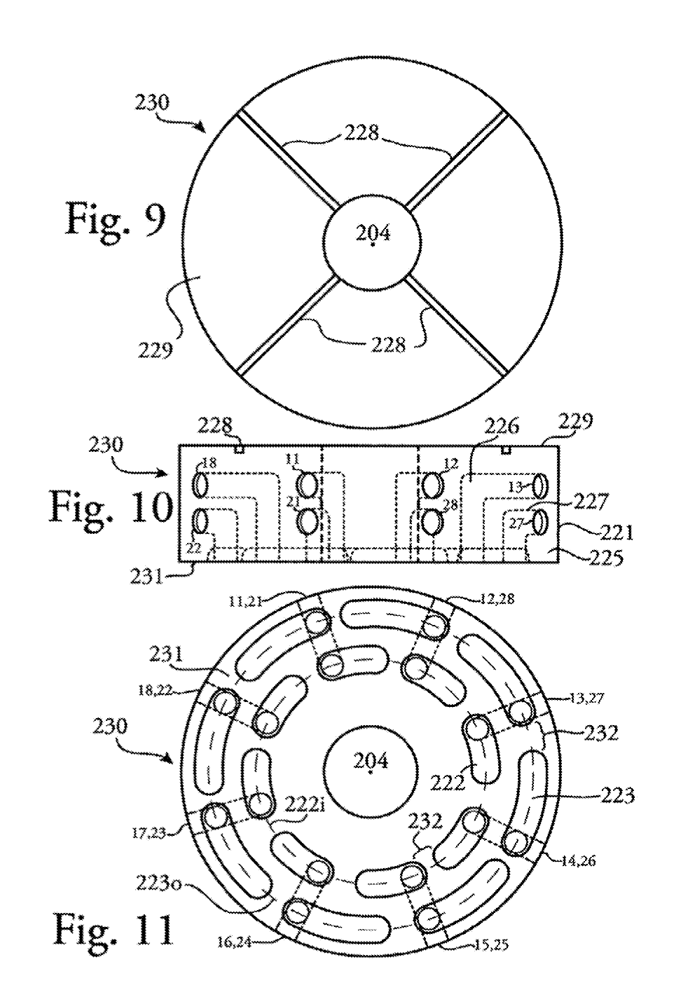

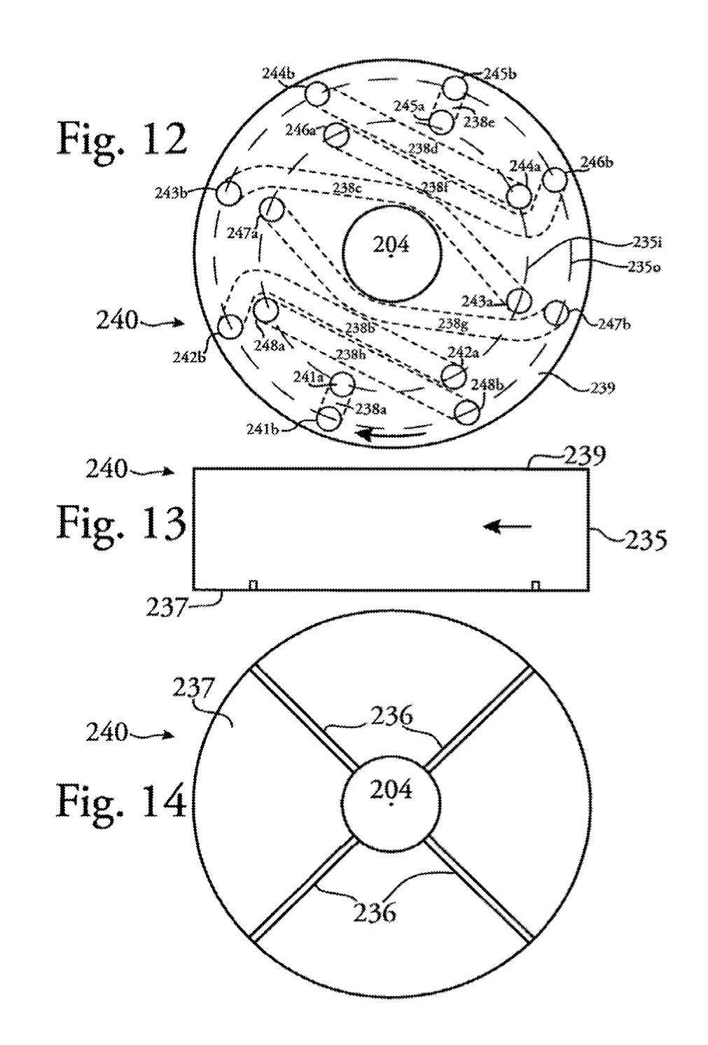

FIGS. 9, 10 and 11 show side and planar views of top stationary head 230, which includes a planar disk 225, made preferably from a polymeric material. The top face 229 of the top stationary head 230 has a sufficient number of machined in keyways 228 for centrally locating and fixing the head by keys 222 to pressure plate 220 shown in FIG. 8 around axis 204. Internal conduits 226 and 227 are machined in the disk 225 and extend from a radially outward surface 221 of the disk to the planar disk valve face 231. On the radially outer surface 221 the internal conduits 226 end in ports 11 through 18 and the internal conduits 227 end in ports 21 through 28. The top ports 11 through 18 are for process fluid external conduits 111-118 and the bottom ports 21-28 are for fluid solid chamber external conduits 121-128 from FIG. 1. On the planar disk valve face 231, internal conduits 226 end in recessed arcuate obround windows 222 and internal conduits 227 end in recessed arcuate obround windows 223. The recessed arcuate obround windows 222 are spaced equidistant around the face and form an inner concentric circle 222i aligned around central axis 204. The recessed arcuate obround windows 223 are spaced equidistant around the face and form an outer concentric circle 223o aligned around central axis 204. The angular lengths of the recessed arcuate obround windows 222 are equal and at least 2× the angular measurement of any of the equal matching holes 241a-248a on the rotating head 240 of FIG. 12. The angular lengths of the recessed arcuate obround windows 223 are equal and at least 2× the angular measurement of any of the equal matching holes 241b-248b on the rotating head 240 of FIG. 12. The angular length of the recessed arcuate obround windows 222 or 223, allows for flow communication of each window with a matching hole 241a-248a or 241b-248b through 2 indexes of the rotating head 240 from FIG. 12. The depth of the recessed arcuate obround windows 222 and 223 is sufficient to allow proper full flow communication with the rotating head 240 of FIG. 3. Between the recessed arcuate obround windows 222 on the inner concentric circle 222i are equal lands 232 that are equal to or preferably slightly less than equal to the angular measurement of holes 241a-248a on the rotating head 240 of FIG. 12. Between the recessed arcuate obround windows 223 on the outer concentric circle 223o are equal lands 232 that are equal to or preferably slightly less than equal to the angular measurement of holes 241b-248b on the rotating head 240 of FIG. 12. The lands 232 formed on the inner concentric circle 222i are equally offset in angular measurement either way from the lands 232 on the outer concentric circle 223o so as to provide a staggered progression of flow communication between the stationary head 230 and the rotating head holes 241a-248a and 241b-248b upon each index of the rotating head 240 of FIG. 12.

Upon a complete reading of the detailed descriptions for the various figures, it will be appreciated that the recessed arcuate obround windows 222 and 223 and corresponding offset of the land 232 between the windows or holes on the inner and outer concentric circles 222i and 223o allows sequential and proper flow between the multiport valves and chambers without any cross contamination of the various fluid streams. A multiport valve formed solely with holes on both the stationary and rotating head sealing faces, without the recessed arcuate obround windows and offsets will function, but with a different sequence and a resultant cross contamination. It will also be appreciated that the recessed arcuate obround windows 222 and 223 and corresponding offset of the land 232 between the windows or holes on the inner and outer concentric circles can be moved from the stationary head 230 to the rotating head 240 in any combination. The recessed arcuate obround windows can be placed on one head, either the stationary 230 or the rotating 240, while the land offset between windows or holes will also be placed on one head, either the stationary 230 or the rotating head 240. Therefore, there are at least 4 combinations of recessed arcuate obround windows and land offset that allows for proper flow communication between the stationary head 230 and rotating head 240. It is critical to note that the top and bottom rotating heads 240 and 260 must move in concert so as to maintain the proper and complimentary flow paths.

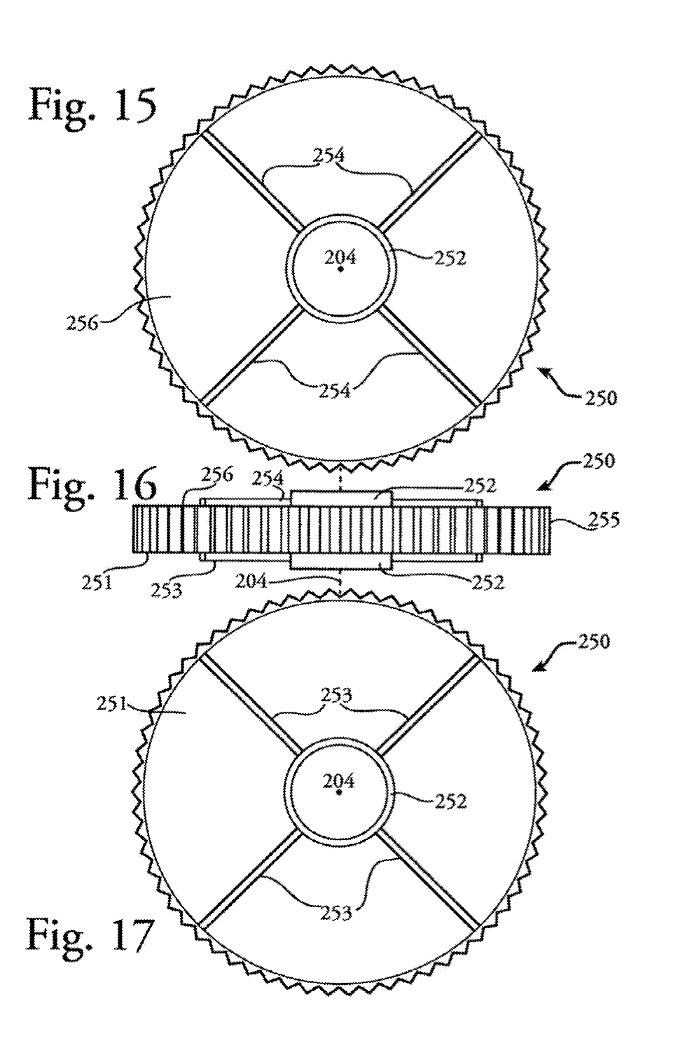

FIGS. 12, 13 and 14 show side and planar views of top rotating head 240 which includes a planar disk 235 of the afore mentioned material, preferably with a metal planar face 239. The bottom face 237 of the top rotating head 240 has a sufficient number of machined in keyways 236 for centrally locating and fixing the head by keys 254 to the sprocket plate 250 of FIG. 3 and FIG. 15 around axis 204. The top planar disk face 239 has holes 241a-248a that are spaced equidistant and form an inner concentric circle 235i and are in communication with recessed arcuate obround windows 222 in FIG. 11. The top planar disk face 239 has holes 241b-248b that are spaced equidistant and form an outer concentric circle 235o and are in communication with recessed arcuate obround windows 223 in FIG. 11. In this embodiment, the holes in the inner and outer concentric circles are sufficient for proper flow and are equal in diameter and are angularly equidistant apart and aligned radially in angular measurement. For this example, eight fluid solid chambers were used and therefore there are eight inner and eight outer holes, but any number of chambers and pairs of holes can be used equal to or greater than two. It is critical that numbering of the holes 241a-248a on the inner concentric circle 235i and 241b-248b on the outer concentric circle 235o, start at a nearest neighbor and proceed in opposite directions resulting in a very specific pattern of internal transverse conduits that redirect the flow between holes on the inner and outer concentric circles. In this embodiment, 241a on the inner concentric circle starts the pattern and connects to the nearest neighbor on the outer concentric circle, which is labeled 241b. Proceeding from that point, the inner concentric circle holes are labeled consecutively proceeding counterclockwise, looking from the top. Similarly, the outer concentric circle holes are labeled consecutively proceeding in an opposite or clockwise direction, looking from the top. Internal transverse conduits 238 are machined internally into the disk 235 in a pattern so as to connect each inner hole to an outer hole in the pattern of 241a to 241b, 242a to 242b, through to 248a to 248b. It is critical in a combined multiport rotary valve that the top multiport rotary valve 215 is aligned with the bottom multiport rotary valve 285 so as the flows between the valves are complimentary. For ease of manufacturing, it is envisioned that the top planar face 239 may be made of one of the previously referenced metals, while the internal conduits are machined into a number of easily machinable disk materials and combined to form a composite disk 235.

FIGS. 15, 16 and 17 show the central sprocket gear assembly 250 preferably made of metal that provides for rotational movement of the rotating heads 240 and 260. The sprocket is axially aligned around the central shaft 205 and axis 204 by bearings 252. The bearings allow for smooth and precise rotation of the sprocket without impeding slight vertical movement of the various heads 230, 240, 260 and 270. FIGS. 15 and 17 show keys 254 and 253 for centrally locating and fixing the rotating heads 240 and 260 of FIG. 3. The keys provide for rotational force to the rotating heads when the sprocket is moved. The sprocket has teeth 255 for engagement with the chain 291 and drive motor 292 of FIG. 2.

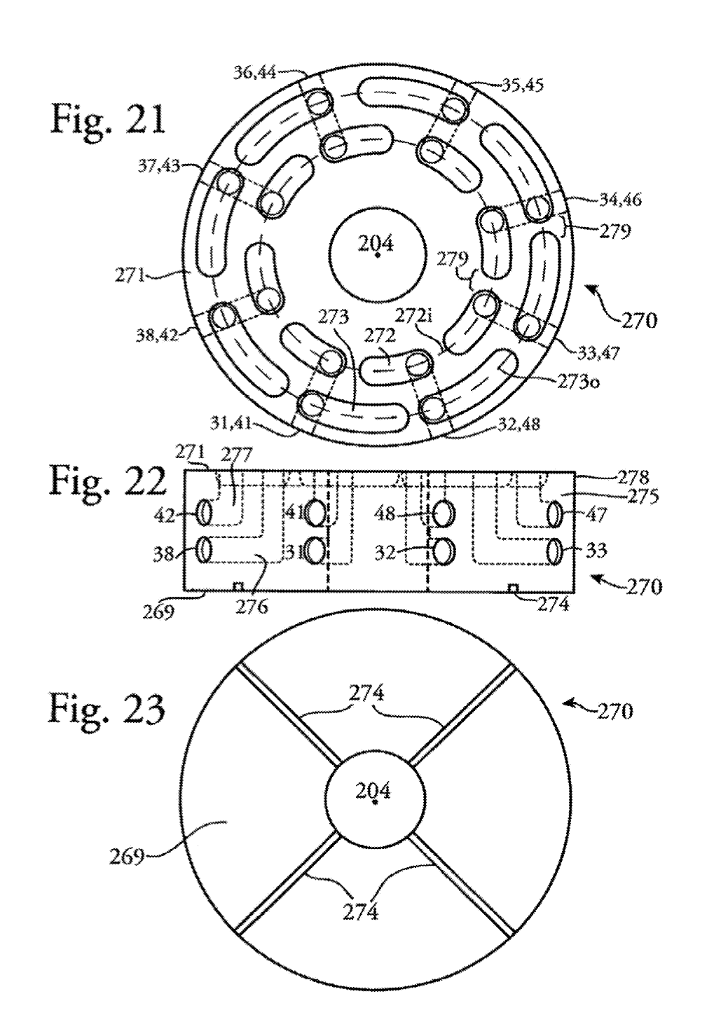

FIGS. 18, 19 and 20 show side and planar views of bottom rotating head 260 which includes a planar disk 255 of the afore referenced material, preferably with a metal planar face. The top face 261 of the bottom rotating head 260 has a sufficient number of machined in keyways 257 for centrally locating and fixing the head by keys 253 to the sprocket plate 250 of FIG. 17 around axis 204. The bottom planar disk face 259 has holes 261a-268a that are spaced equidistant and form an inner concentric circle 255i and are in communication with recessed arcuate obround windows 272 in FIG. 21. The bottom planar disk face 259 has holes 261b-268b that are spaced equidistant and form an outer concentric circle 255o and are in communication with recessed arcuate obround windows 273 in FIG. 21. In this embodiment, the holes in the inner and outer concentric circles are sufficient for proper flow and are equal in diameter and are angularly equidistant apart and aligned radially in angular measurement. For this example, eight fluid solid chambers were used and therefore there are eight inner and eight outer holes, but any number of chambers and pairs of holes can be used equal to or greater than two. It is critical that numbering of the holes 261a-268a on the inner concentric circle 255i and 261b-268b on the outer concentric circle 255o, start at a nearest neighbor and proceed in opposite directions resulting in a very specific pattern of conduits that redirect the flow between inner and outer holes. In this embodiment, 261a on the inner concentric circle starts the pattern and connects to the nearest neighbor on the outer concentric circle, which is labeled 261b. Proceeding from that point, the inner concentric circle holes are labeled consecutively proceeding clockwise looking from the bottom. Similarly, the outer concentric circle holes are labeled consecutively proceeding in an opposite or counter clockwise direction looking from the bottom. It will be noted that the second multiport valve 285 of FIG. 3 is numbered in mirror image to the top multiport valve 215 and vertically aligned at the same starting point numbers so as to maintain complimentary flow paths between the valves. Internal transverse conduits 258 are machined internally into the disk 255 in a pattern so as to connect each inner hole to an outer hole in the pattern of 261a to 261b, 262a to 262b, through to 268a to 268b. For ease of manufacturing, it is envisioned that the top planar face 259 may be made one of the previously referenced metals, while the internal conduits are machined into a number of easily machinable disk materials and combined to form a composite disk 255.

Rotating head 260 has 2× the number of targets 293 as number of chambers described in FIG. 1 and are made of any such material that can be registered by proximity sensor 294. The targets 293 are precisely located around the rotating head 260 to indicate when the rotary and stationary head holes and recessed arcuate obround windows are aligned. In the example discussed in FIG. 1, there are eight chambers and 16 targets aligned with the 16 possible flow paths.

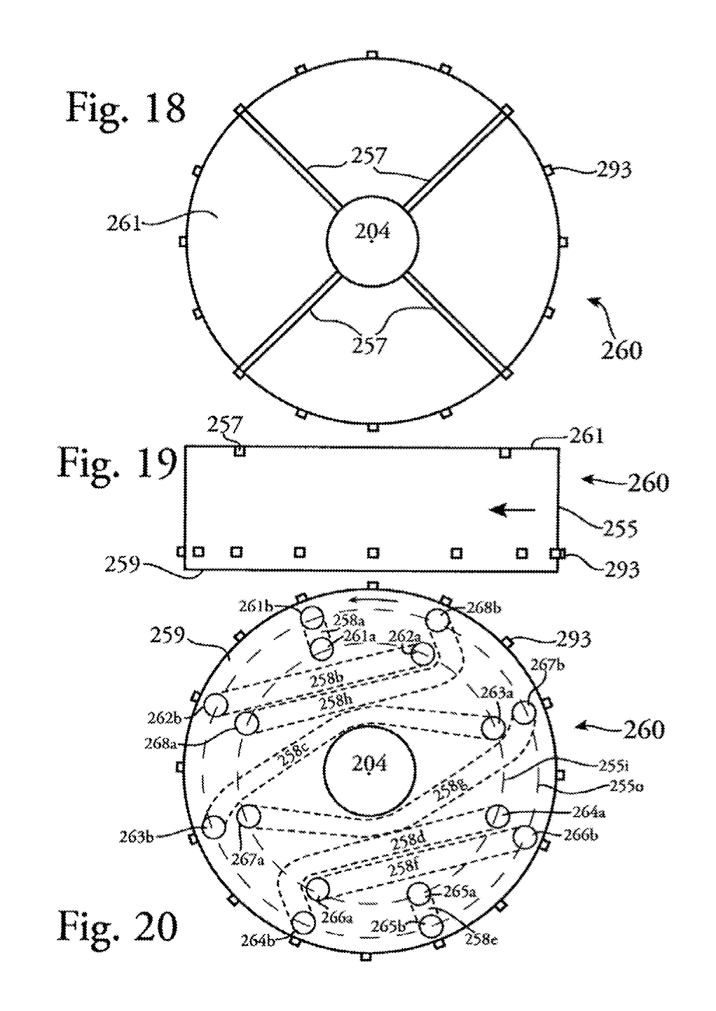

FIGS. 21, 22 and 23 show side and planar views of bottom stationary head 270, which includes a planar disk 275, made preferably from a polymeric material. The bottom face 269 of the bottom stationary head 270 has a sufficient number of machined in keyways 274 for centrally locating and fixing the head by the keys 281 to end plate 280 of FIG. 2b and FIG. 24 around axis 204. Internal conduits 276 and 277 are machined in the disk 275 and extend from a radially outward surface 278 of the disk to the planar disk valve face 271. On the radially outer surface 278 the internal conduits 276 end in ports 31 through 38 and the internal conduits 277 end in ports 41 through 48. The bottom ports 31 through 38 are for process fluid conduits 131-138 and the top ports 41-48 are for fluid solid chamber conduits 141-148 from FIG. 1. On the planar disk valve face 271, internal conduits 276 end in recessed arcuate obround windows 272 and internal conduits 277 end in recessed arcuate obround windows 273. The recessed arcuate obround windows 272 are spaced equidistant around the face and form an inner concentric circle 272i aligned around central axis 204. The recessed arcuate obround windows 273 are spaced equidistant around the face and form an outer concentric circle 273o aligned around central axis 204. The angular lengths of the recessed arcuate obround windows 272 are equal and at least 2× the angular measurement of any of the equal matching holes 261a-268a on the rotating head 260 of FIG. 20. The angular lengths of the recessed arcuate obround windows 273 are equal and at least 2× the angular measurement of any of the equal matching holes 261b-268b on the rotating head 260 of FIG. 20. The angular length of the recessed arcuate obround windows, 272 or 273 allows for flow communication of each window with a matching hole 261a-268a or 261b-268b through 2 indexes of the rotating head 260 of FIG. 20. The depth of the recessed arcuate obround windows 272 and 273 is sufficient to allow proper full flow communication with the rotating head 260 of FIG. 3. Between the recessed arcuate obround windows 272 on the inner concentric circle 272i are equal lands 279 that are equal to or preferably slightly less than equal to the angular measurement of holes 261a-268a on the rotating head 260 of FIG. 20. Between the recessed arcuate obround windows 273 on the outer concentric circle 273o are equal lands 279 that are equal to or preferably slightly less than equal to the angular measurement of holes 261b-268b on the rotating head 260 of FIG. 20. The lands 279 formed on the inner concentric circle 272i are equally offset in angular measurement either way from the lands 279 on the outer concentric circle 273o so as to provide a staggered progression of flow communication between the stationary head 270 and the rotating head holes 261a-268a and 261b-268b upon each index of the rotating head 260 of FIG. 20.

Again, upon a complete reading of the detailed descriptions for the various figures, it will be appreciated that the recessed arcuate obround windows 272 and 273 and corresponding offset of the land 279 between the windows or holes on the inner and outer concentric circles allows sequential and proper flow between the multiport valves and chambers without any cross contamination of the various fluid streams. A multiport valve formed solely with holes on both the stationary and rotating head sealing faces, without the recessed arcuate obround windows and offsets will function, but with a different sequence and a resultant cross contamination. It will also be appreciated that the recessed arcuate obround windows 272 and 273 and corresponding offset of the land 279 between the windows and holes on the inner and outer concentric circles can be moved from the stationary head 270 to the rotating head 260 in any combination. The recessed arcuate obround windows can be placed on one head, either the stationary 270 or the rotating 260, while the land offset will also be placed on one head, either the stationary 270 or the rotating head 260. Therefore, there are at least 4 combinations of recessed arcuate obround windows and land offset that allow for proper flow communication between the stationary head 270 and rotating head 260. It is critical to note that the top and bottom rotating heads 240 and 260 must move in concert so as to maintain the proper and complimentary flow paths.

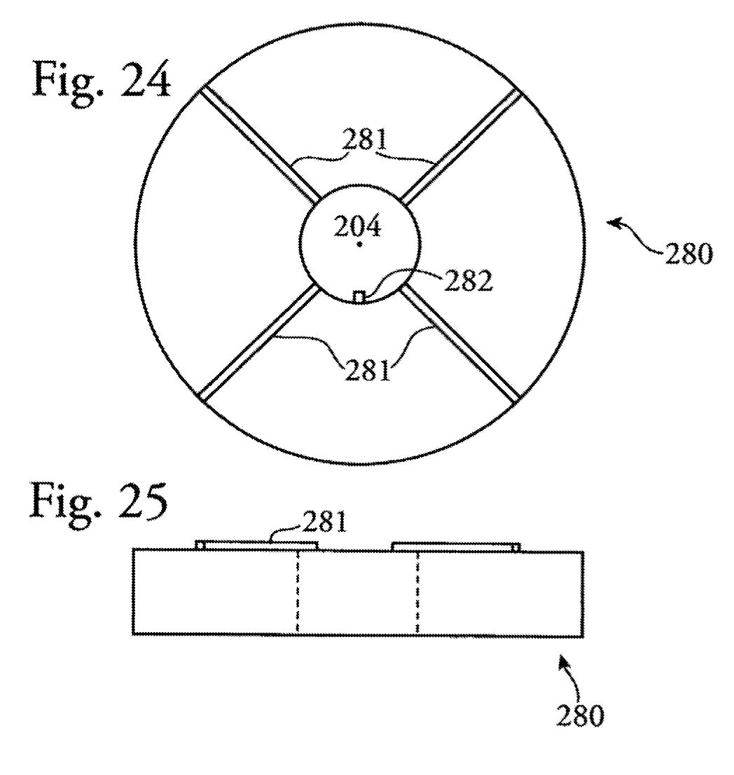

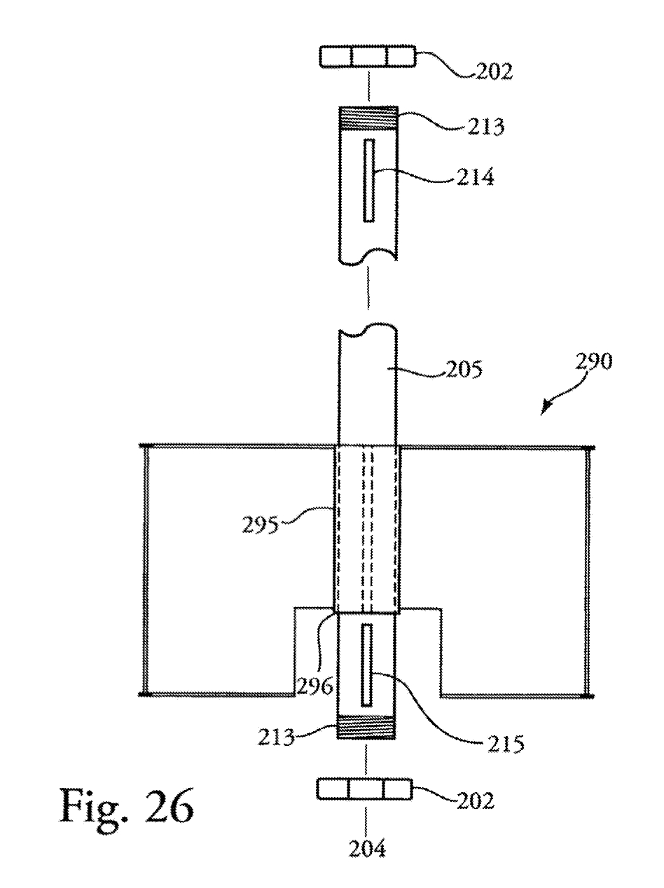

FIGS. 24 and 25 show the bottom end plate 280, preferably made of metal, axially aligned around the central axis 204. FIG. 24 shows keys 281 for fixing and centrally locating the bottom stationary head 270 of FIG. 23 around the central axis 204. Key 282 fixes the bottom end plate 280 with the keyed central shaft 205 of FIG. 2b and FIG. 26. The end plate 280 provides a face for opposing the force from the pressure plate 220 of FIG. 7.

FIG. 26 shows a side view of multiport rotary valve stand 290 and shaft 205 with threaded ends 213 and keyways 214 to mate with key 208 from FIG. 4 and keyway 215 for mating with key 282 from FIG. 24. The stand is preferably made of metal and designed so as to adequately support the end plate 280 of FIG. 25 yet not unreasonably obstruct the valve heads. End plate 280 can be affixed to stand 290 in any suitable way so as to avoid rotation of the end plate 280. Stand 290 is also designed to adequately fix central shaft tube 295 which limits horizontal movement of shaft 205 while surface 296 provides a flat for constraining the vertical movement of shaft by nuts 202.

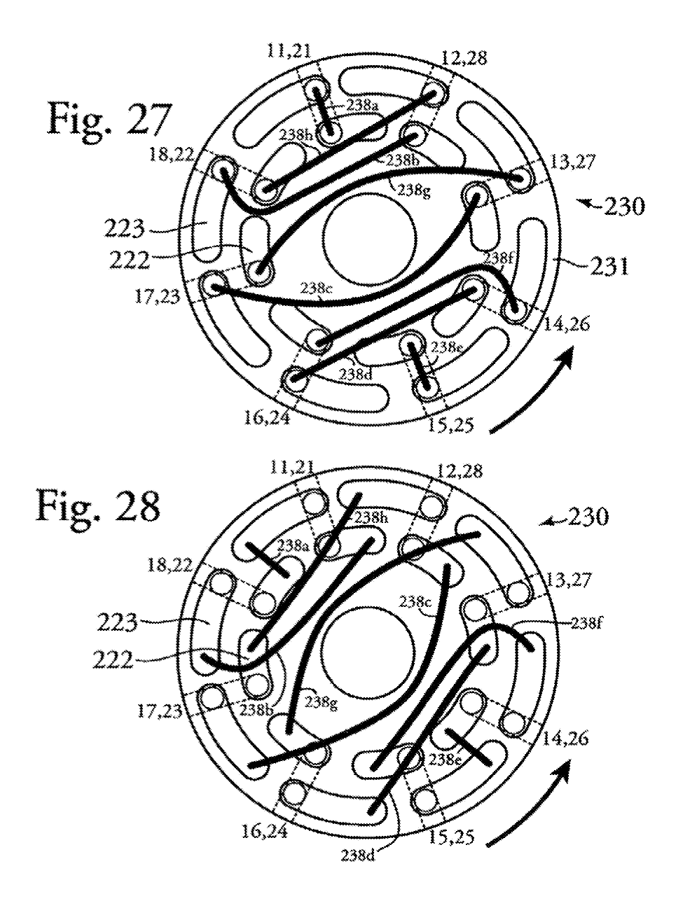

FIG. 27 is an example of how the internal transverse conduits 38 of rotating head 240 from FIG. 12 redirect the flow back into stationary head 230 of FIGS. 10 and 11 before an index of the rotating head 240. The stationary head 230 is shown in plan view, looking up, with bottom face 231 exposed. The recessed arcuate obround windows 222 on the inner concentric circle connect to ports 11-18 by internal conduits 226 and recessed arcuate obround windows 223 on the outer concentric circle connect to ports 21-28 by internal conduits 227 as per FIG. 10. The internal transverse conduits 238 which connect to holes 241a-248a and 241b-248b in rotating head 240 from FIG. 12 are in communication with stationary head 230 and are shown in dark overlay on the face 231 of the stationary head 230. It can be seen that port 11 will connect to port 21 through internal transverse conduit 238a. Port 12 will connect to port 22 through internal transverse conduit 238b and so on, until port 18 will connect with port 28 through internal transverse conduit 238h.

FIG. 28 is an example of how the internal transverse conduits 38 of rotating head 240 from FIG. 12 redirect the flow back into stationary head 230 of FIGS. 10 and 11 after one index of the rotating head 240. Internal transverse conduits 238 have been indexed one position from that in FIG. 27 counterclockwise looking from a bottom perspective. Port 11 will now connect to port 22 though internal transverse conduit 238b. Port 12 will connect to port 23 through internal transverse conduit 238c and so on until port 18 will connect to port 21 by internal transverse conduit 238a. In this manner, the internal transverse conduits sequentially move the flows from one chamber to the next upon each index. Combining the top multiport valve 215 with the bottom multiport valve 285 and indexing both valves in concert, allows proper and sequential flow through the various chambers. In the 8 chamber example two complete cycles are accomplished in each revolution of the rotating heads. Combining this concept with the water softener example described in FIG. 1, it can be seen how the chambers move sequentially through the entire process.

Therefore, the combined multiport rotary valve 200 with recessed arcuate obround windows and offsets operates as follows: By means of the drive motor 292 the rotating heads 240, 260 are moved together to a position where a target 293 aligns with the proximity sensor 294. For this example, the rotating heads are aligned so stream A will connect with fluid solid chamber 1 as will the other streams B through H align with fluid solid chambers 2 through 8. Referring back to FIGS. 1, 10-12, 20-22 and 27 for the above-mentioned water softening application and using only feed water stream A as an example, stream A will enter by conduit 111l the invention 200 at port 11 of the top stationary head 230 and proceeds through an internal conduit 226 to a recessed arcuate obround window 222 on the inner concentric circle 222i at the planar face 231 disposed in sealing contact with the top rotating head planar face 239, the flow enters the rotating head hole 241a on the inner concentric circle 235i and proceeds through internal transverse conduit 238a to hole 241b on the outer concentric circle 235o on the top rotating head planar face 239 and reenters the top stationary head 230 at a recessed arcuate obround window 223 at the outer concentric circle 223o and proceeds by an internal conduit 227 to the stationary head port 21. Stream A then proceeds by conduit 121 to enter the first fluid solid contacting chamber 1 by 1a and makes contact with the treatment resin contained therein, it then exits chamber 1 at 1b as treated stream A′ and enters by conduit 141 the bottom stationary head 270 at port 41. Treated stream A′ then proceeds by an internal conduit 277 to a recessed arcuate obround window 273 on the outer concentric circle 273o on the top planar face 271 of the bottom stationary head 270 disposed in sealing contact with the bottom rotating head planar face 259 and proceeds into the bottom rotating head at hole 261b on the outer concentric circle 255o. Stream A′ proceeds by internal transverse conduit 258a through the bottom rotating head 260 and is redirected to the rotating head planar surface 259 and hole 261a on the inner concentric circle 255i. Stream A′ crosses back through the planar surface to bottom stationary head 270 and enters by a recessed arcuate obround window 272 on the inner concentric circle 272i and proceeds by conduit 276 to exit the invention at port 31 and external conduit 131. In this 8-chamber example, the other 7 streams will proceed to their respective 7 chambers through their respective paths. The 8 fluid streams will continue with the same paths until such a time when a control device initiates an index of the rotary heads 240 and 260 one position clockwise when viewed from the top, to the next target position 293.

After the first clockwise index, stream A enters the invention 200 by conduit 111 at port 11 of the top stationary head 230 and proceeds through an internal conduit 226 to a recessed arcuate obround window 222 on the inner concentric circle 222i at the planar face 231 disposed in sealing contact with the top rotating head planar face 239. Due to the rotation of head 240, stream A enters a new rotating head hole 242a on the inner concentric circle 235i and proceeds through the internal transverse conduit 238b to hole 242b on the outer concentric circle 235o on the top rotating head planar face 239 and reenters the top stationary head 230 at a recessed arcuate obround window 223 on the outer concentric circle 223o, passes through an internal conduit 227 and exits at port 22. Stream A then proceeds by conduit 122 to enter by 2a the second fluid solid contacting chamber 2 and makes contact with the treatment resin contained therein, it then exits the chamber at 2b as treated stream A′ and proceeds by conduit 142 to enter the bottom stationary head 270 at port 42. Treated stream A′ then proceeds by an internal conduit 277 to a recessed arcuate obround window 273 on the outer concentric circle 273o on the top planar face 271 of the bottom stationary head 270 disposed in sealing contact with the bottom rotating head planar face 259. Due to the recessed arcuate obround window 273 in the bottom stationary head 270, treated stream A′ proceeds back into the bottom rotating head 260 at the previous hole 261b on the outer concentric circle 255o. Stream A′ proceeds by the internal transverse conduit 258a in the bottom rotating head 260 and is redirected to hole 261a on the inner concentric circle 255i on the rotating head planar surface 259. Stream A′ crosses back through the planar surface to bottom stationary head 270 and enters by a recessed arcuate obround window 272 on the inner concentric circle 272i associated with port 31 and proceeds to exit the invention by conduit 131.

After the second clockwise index, stream A enters the invention by conduit 111 at port 11 of the top stationary head 230 and proceeds through an internal conduit 226 to a recessed arcuate obround window 222 on the inner concentric circle 222i at the planar face 231 disposed in sealing contact with the top rotating head planar face 239. Due to the recessed arcuate obround window 222, stream A continues to enter the previous rotating head hole 242a on the inner concentric circle 235i and proceeds through the internal transverse conduit 238b to hole 242b on the outer concentric circle 235o on the top rotating head planar face 239. The stream now reenters the top stationary head 230 at a recessed arcuate obround window 223 on the outer concentric circle 223o, passes through an internal conduit 227 and exits at port 23. Stream A then proceeds by conduit 123 to enter by 3a the third fluid solid contacting chamber and makes contact with the treatment resin contained therein, it then exits the chamber at 3b as Treated stream A′ and proceeds by conduit 143 to enter the bottom stationary head 270 at port 43. Treated stream A′ then proceeds by an internal conduit 277 to a recessed arcuate obround window 273 on outer concentric circle 273o on the top planar face 271 of the bottom stationary head 270 disposed in sealing contact with the bottom rotating head planar face 259 and because of the recessed arcuate obround window proceeds back into the bottom rotating head at the same hole 262b on the outer concentric circle 255o. Stream A′ proceeds by internal transverse conduit 258b through the bottom rotating head 260 and is redirected to hole 262a on the inner concentric circle 255i on the rotating head planar surface 259. Stream A′ crosses back through the planar surface to bottom stationary head 270 and enters by a recessed arcuate obround window 272 on the inner concentric circle 272i and proceeds by internal conduit 276 to exit the invention 200 at port 31 and conduit 131. The third index will move stream A through chamber 4 and so on until stream A comes back to chamber 1 upon the 8th index which is one half of a complete cycle or 180 angular degrees. This pattern will proceed upon each index until it has completed the sequence 2× in one 360-degree revolution of the rotating heads. All of the other chambers will follow the same pattern so as to move each chamber counter currently and sequentially through the various feed streams A through H.

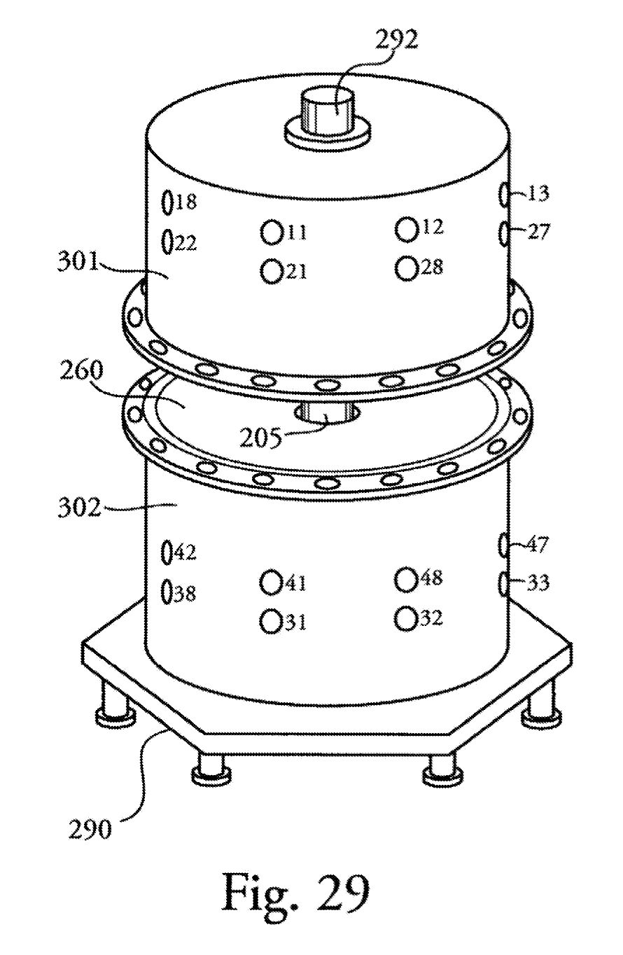

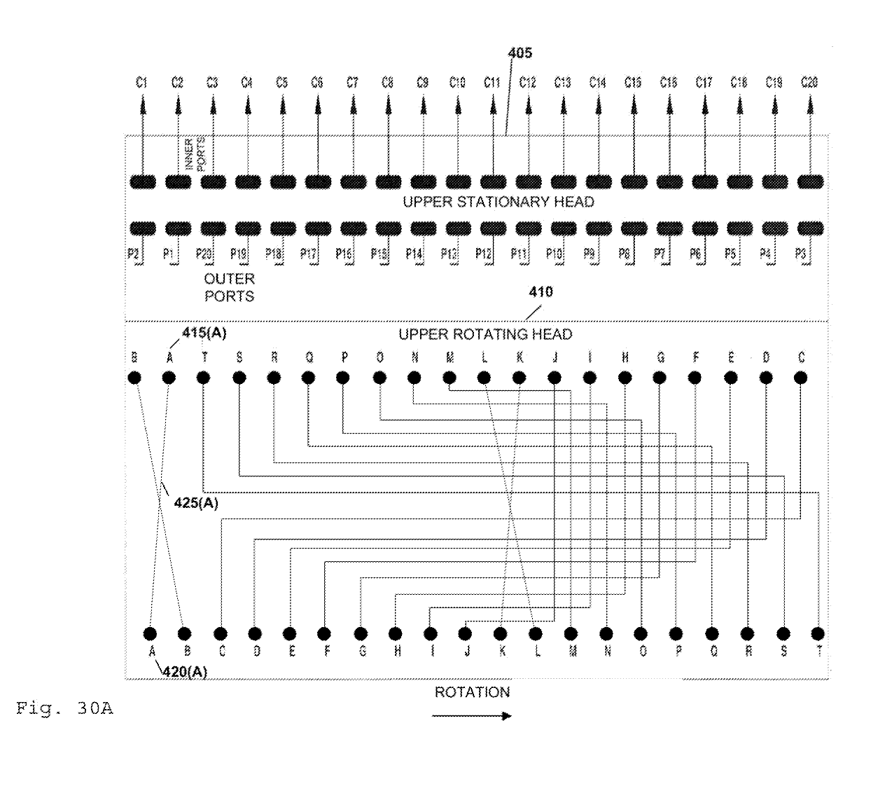

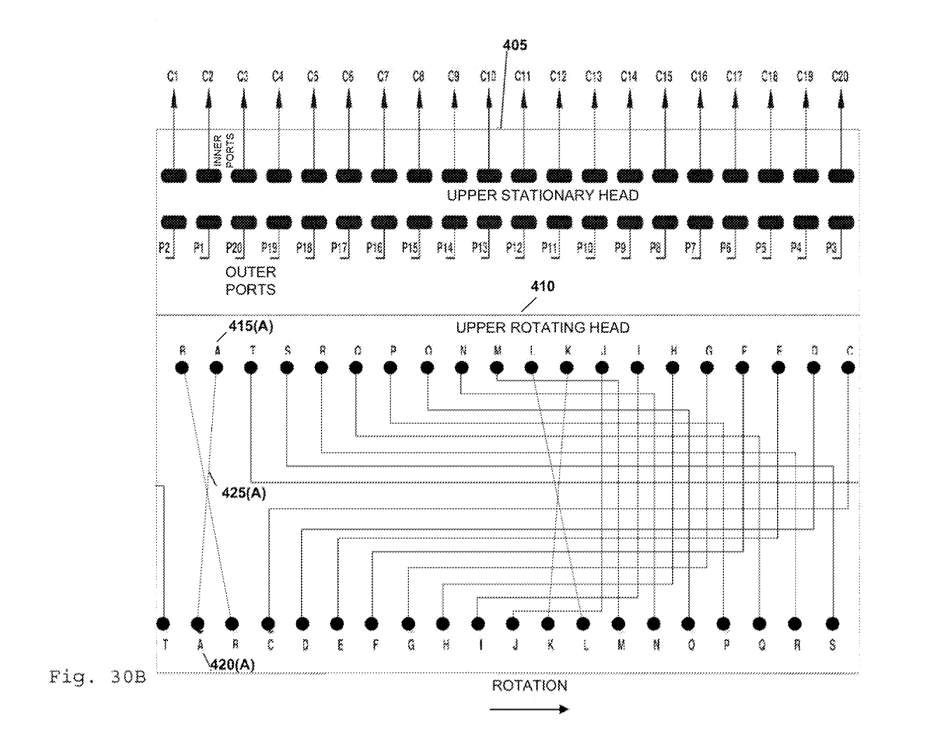

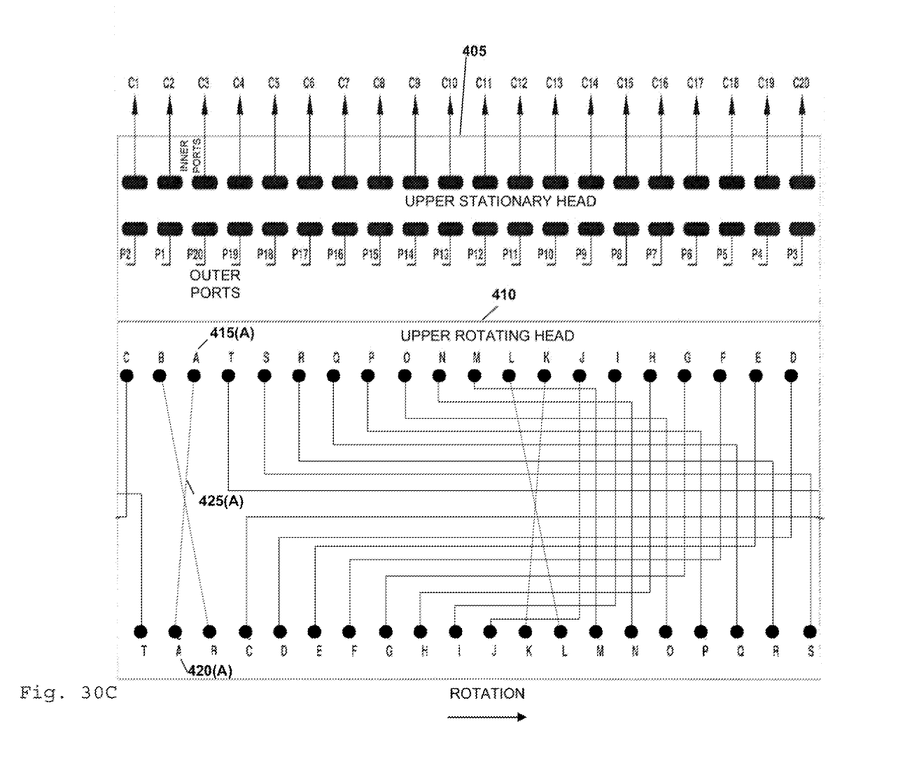

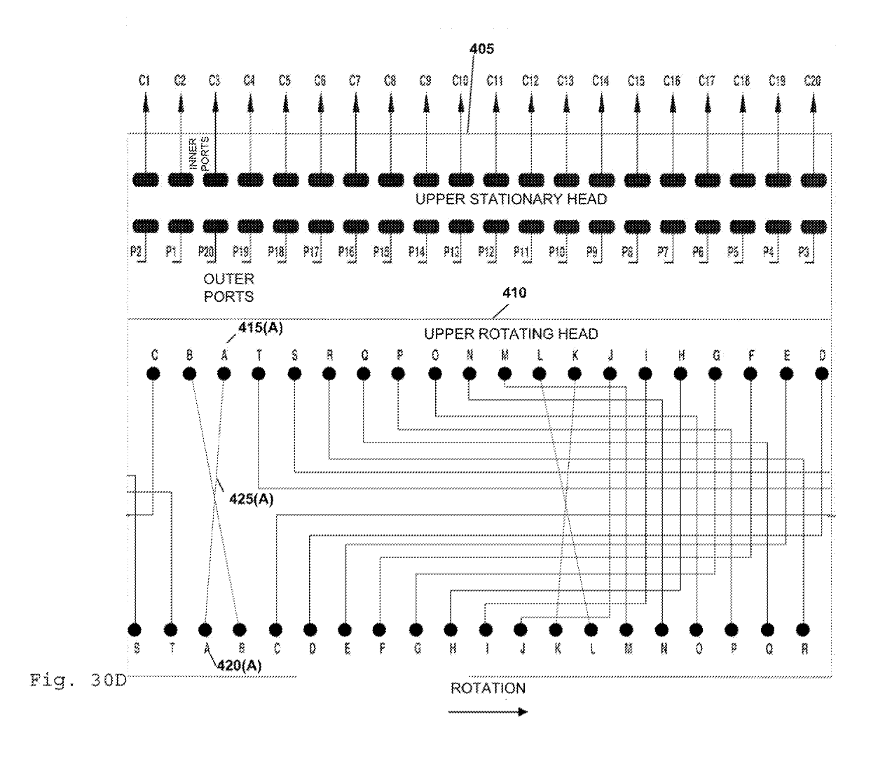

FIG. 29 shows an alternative stand and housing for the combined multiport rotary valve 200 using an outer clamshell housing 301 and 302 combined with a motor and gearbox 292 driving the central drive shaft 205 on valve stand 290. The outer clamshell housing will prevent rotation of the stationary heads, while allowing the rotating heads to move. The central drive shaft will be connected to the rotating heads and drive them at the proper time. The outer housing will encase and urge the rotating and stationary heads together around a central shaft by mechanical, hydraulic or pneumatic means.

FIG. 30A depicts a graphical representation of an exemplary 20-port valve in a first position according to an embodiment. As shown in FIG. 30A, each valve includes a stationary head 405 and a rotating head 410. The stationary head 405 remains stationary and the rotating head 410 rotates during operation.

The stationary head 405 includes a plurality of first ports, such as P1-20, and a plurality of second ports, such as ports C1-20. Each first port P1-20 is connected to a pipe, tube or other channel (not shown) that provides a fluid stream for performing a particular step of, for example, an ion exchange process. Each second port C1-20 is connected to a media vessel (not shown) containing, for example, a fluid-solid mixture on which the process operates. The media vessels remain stationary during the process because the attachment to the stationary head does not move as a result of the process. More or fewer first ports and second ports may be incorporated into a stationary head 405 within the scope of this disclosure.

The rotating head 410 includes a plurality of first ports, such as 415(A), a plurality of second ports, such as 420(A), and a plurality of channels, such as 425(A), connecting each first port to a corresponding second port. Each of the first ports 415 and the second ports 420 labeled in FIG. 30A with a common letter (A-T) correspond to each other and are connected by a corresponding channel 425.

In operation, fluid directed to a first port, such as P1, of the stationary head 405 is passed to a first port, such as 415(A), of the rotating head 410 with which it is aligned at that time. The fluid flows through the corresponding channel 425(A) of the rotating head 410 to the corresponding second port 420(A) of the rotating head. The fluid is then directed to the second port C1 of the stationary head 405 with which the second port 420(A) of the rotating head 410 is aligned at that time.

As shown in FIG. 30A, the first ports P1-20 and second ports C1-20 of the stationary head 405 are substantially wider than the first ports 415 and the second ports 420 of the rotating head 410. In an embodiment, the first ports P1-20 and second ports C1-20 of the stationary head 405 are approximately 3 times wider than the first ports 415 and the second ports 420 of the rotating head 410. In other words, the angular lengths of the first ports P1-20 and second ports C1-20 of the stationary head 405 may be longer than (e.g., approximately 3 times longer than) the angular lengths of the first ports 415 and the second ports 420 of the rotating head 410. Accordingly, in FIG. 30A, fluid flowing from first port P1 of the stationary head 405 to first port 415(A) of the rotating head 410 flows from the left-hand side of first port P1. Similarly, fluid flowing from the second port 420(A) of the rotating head 410 flows through the right-hand side of second port C1 of the stationary head 405. As such, fluids flowing from first ports P1-20 of the stationary head 405 are directed to second ports C1-20 of the stationary head in the first valve position depicted in FIG. 30A.

FIG. 30B depicts a graphical representation of the exemplary 20-port valve in a second position according to an embodiment. FIG. 30B depicts the valve in the second position in which the rotating head 410 has rotated 9° ( 1/40 of a complete revolution) from its position in FIG. 30A. In general, the rotation between each position equals 1 divided by 2 times the number of first ports.

As shown in FIG. 30B, fluid flowing from first port P1 of the stationary head 405 to first port 415(A) of the rotating head 410 flows from the right-hand side of first port P1. Similarly, fluid flowing from the second port 420(A) of the rotating head 410 flows through the left-hand side of second port C2 of the stationary head 405. As such, fluids flowing from first ports P1-20 of the stationary head 405 are directed to second ports C2-20 and C1, respectively, of the stationary head in the second valve position depicted in FIG. 30B.

FIG. 30C depicts a graphical representation of the exemplary 20-port valve in a third position according to an embodiment. FIG. 30C depicts the valve in the third position in which the rotating head 410 has rotated 9° ( 1/40 of a complete revolution) from its position in FIG. 30B.

As shown in FIG. 30C, fluid flowing from first port P1 of the stationary head 405 to first port 415(B) of the rotating head 410 flows from the left-hand side of first port P1. Similarly, fluid flowing from the second port 420(B) of the rotating head 410 flows through the right-hand side of second port C3 of the stationary head 405.l As such, fluids flowing from first ports P1-20 of the stationary head 405 are directed to second ports C3-20 and C1-C2, respectively, of the stationary head in the third position depicted in FIG. 30C.

FIG. 30D depicts a graphical representation of the exemplary 20-port valve in a fourth position according to an embodiment. FIG. 30D depicts the valve in the fourth position in which the rotating head 410 has rotated 9° ( 1/40 of a complete revolution) from its position in FIG. 30C.

As shown in FIG. 30D, fluid flowing from first port P1 of the stationary head 405 to first port 415(B) of the rotating head 410 flows from the right-hand side of first port P1. Similarly, fluid flowing from the second port 420(B) of the rotating head 410 flows through the left-hand side of second port C4 of the stationary head 405. As such, fluids flowing from first ports P1-20 of the stationary head 405 are directed to second ports C4-20 and C1-C3, respectively, of the stationary head in the fourth position depicted in FIG. 30D.

As the rotating head 410 continues to rotate, each media vessel consecutively receives fluid from the first ports of the stationary head 405. As a result of providing fluid to ports in such a manner, any fluid retained by the passage between the input port and the output port of the stationary head may be passed to an appropriate media vessel.

In an embodiment, a second stationary head (not shown) and a second rotating head (not shown) are aligned with stationary head 405 and rotating head 410 to receive any output from a media vessel. For example, the ports of the second stationary head and stationary head 405 are aligned in a fixed orientation. The ports of the second rotating head and rotating head 410 are aligned and rotate in a fixed orientation with respect to each other.

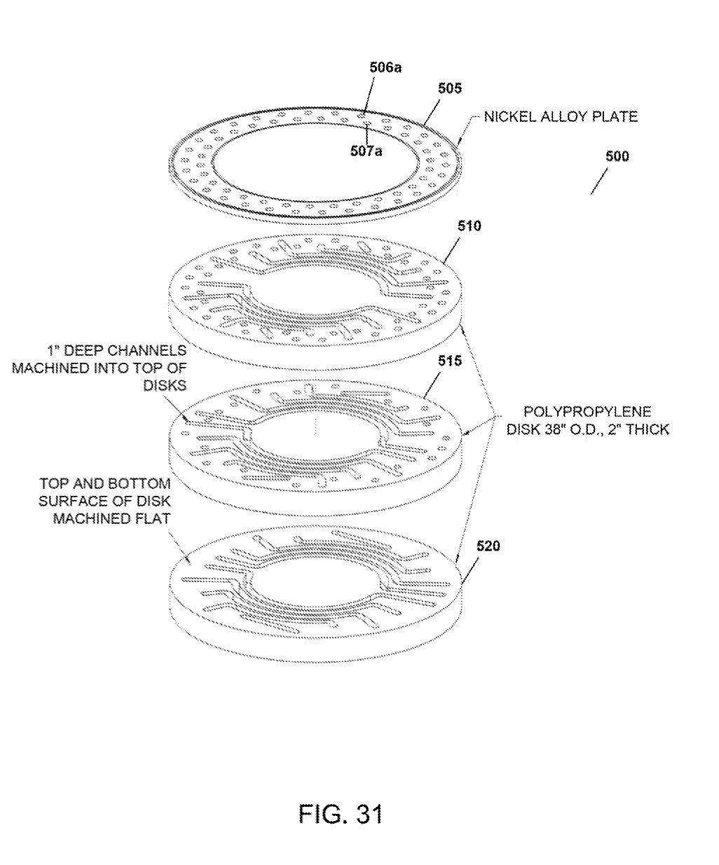

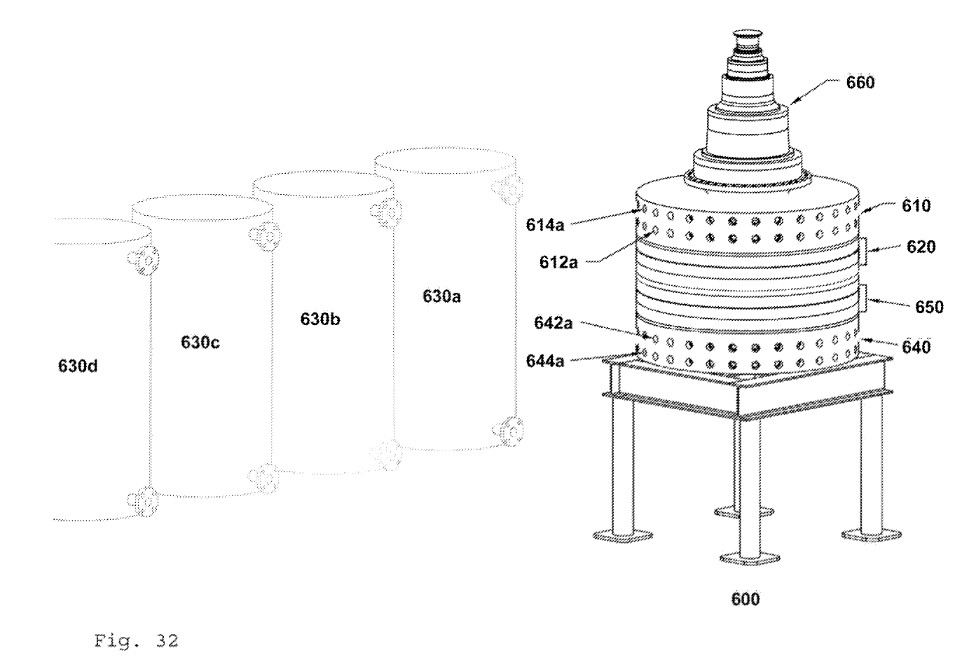

FIG. 31 depicts an exploded view of an exemplary 30-port rotating head assembly according to an embodiment. As shown in FIG. 31, the 30 port rotating head assembly 500 includes a top plate 505 and one or more layered disks, such as 510-520. The top plate 505 includes a plurality of first ports, such as 506a, and a plurality of second ports, such as 507a. Each first port, such as 506a, is aligned with a first port, such as P1, of the stationary head 105, during each step of an ion exchange process. Each second port, such as 507a, is aligned with a second port, such as C1, of the stationary head 105, during each step of an ion exchange process. As the rotating head assembly 500 rotates, the first port 506a and the second port 507a connect to different first and second ports of the stationary head 105.

As fluid enters first port 506a, the fluid enters the assembly and is directed to a channel 508a connecting first port 506a and second port 507a. The channel may be present on and/or may pass through one or more of the layered disks 510-520. In an embodiment, a channel, such as 508a, is appropriately designed for the flow. In this manner, each channel contains the fluid passing from the corresponding output port to the corresponding input port without leaking. Other channel depths and layered disk thicknesses may be used within the scope of this disclosure. In addition, differing numbers of layered disks may be used depending upon the width of the channels, the width of the disks, and the number of channels to be implemented. Such modifications to the depicted embodiment are further incorporated within the scope of this disclosure.

FIG. 32 depicts an exemplary multiport apparatus for directing fluid according to an embodiment. As shown in FIG. 32, the apparatus 600 includes a first stationary head 610, a first rotating head 620, a plurality of media vessels, such as 630a-d, a second stationary head 640, a second rotating head 650 and a rotating system 660.

The first stationary head 610 includes a plurality of first ports, such as 612a, and a corresponding plurality of second ports, such as 614a. The number of first ports 612a equals the number of second ports 614a. Each first port 612a is configured to receive fluid from a fluid source (not shown). Each second port 614a directs fluid to a corresponding media vessel, such as 630a.

The first rotating head 620 includes a plurality of first ports, such as 506a in FIG. 31, a corresponding plurality of second ports, such as 507a in FIG. 31, and a plurality of channels, such as 508a in FIG. 31, connecting each first port to the corresponding second port. The number of first ports 506a equals the number of second ports 507a. Each first port 506a is configured to receive fluid from a first port, such as 612a, of the first stationary head 610 with which it is aligned at a given time. The received fluid passes through the first port 506a, the corresponding channel 508a and the corresponding second port 507a. The fluid then passes to a second port, such as 614a, on the first stationary head 610 with which the second port 507a is aligned.

The fluid is directed from the second port 614a of the first stationary head 610 to a corresponding media vessel, such as 630a. Each media vessel 630a is used to perform, for example, an ion exchange process. The fluid directed from the second port 614a of the first stationary head 610 is used to perform a step of such a process. Other processes may also be performed within the scope of this disclosure. Each media vessel, such as 630a, remains stationary during performance of the process and remains attached to a corresponding second port 614a of the first stationary head 610 and a corresponding second port, such as 644a, of the second stationary head 640.

The second stationary head 640 includes a plurality of first ports, such as 642a and a plurality of second ports, such as 644a. The number of first ports 642a is equal to the number of second ports 644a. Each second port 644a receives fluid output from a corresponding media vessel, such as 630a. The output from the media vessel 630a is provided to a second port, such as 644a of a second stationary head 640. Each first port 642a directs fluid to an output.

The second rotating head 650 includes a plurality of first ports, such as 506a in FIG. 31, a corresponding plurality of second ports, such as 507a in FIG. 31, and a plurality of channels, such as 508a in FIG. 31, connecting each first port to the corresponding second port. The number of first ports 506a equals the number of second ports 507a. Each second port, such as 507a, is configured to receive fluid from a second port, such as 644a, of the second stationary head 640 with which it is aligned at a given time. The received fluid passes through the second port 507a, the corresponding channel 508a and the corresponding first port 506a. The fluid then passes to a first port, such as 644a, on the second stationary head 640 with which the first port 506a is aligned.

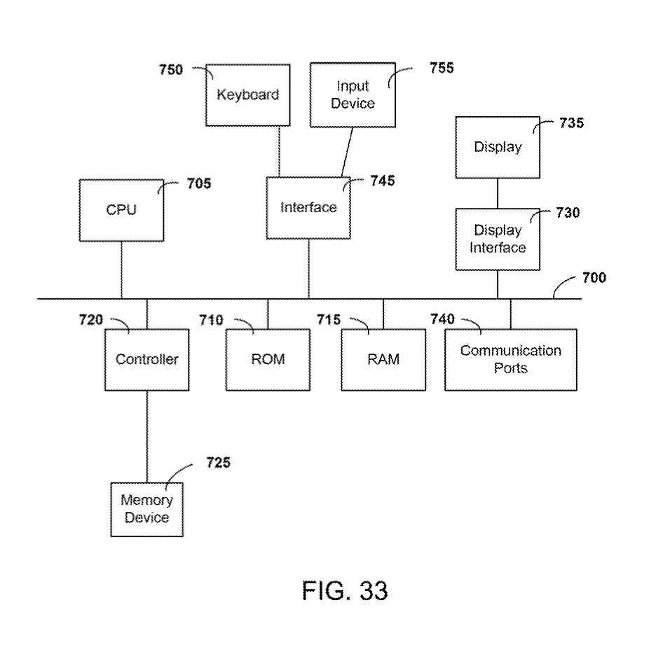

The rotating system 660 includes a motor, such as a step motor. In an embodiment, the rotating system includes a controller, such as a computer system used to operate the mechanical components of the rotating system, such as the motor. An exemplary computer system is described in more detail in FIG. 33.

The rotating system 660 is used to rotate the first rotating head 620 and the second rotating head 650. In an embodiment, the first rotating head 620 and the second rotating head 650 are aligned such that each first port 622a-N of the first rotating head is aligned with a corresponding first port 652a-N of the second rotating head, and each second port 624a-N of the first rotating head is aligned with a corresponding second port 654a-N of the second rotating head. Other alignments are possible within the scope of this disclosure.

The rotating system 660 causes the first rotating head 620 and the second rotating head 650 to rotate a fixed number of degrees in each cycle. In an embodiment, the rotating system 660 causes the first rotating head 620 and the second rotating head 650 to rotate approximately

$$\frac{180}{num\_of \_ports}$$

degrees per cycle as discussed above in reference to FIGS. 30A-D.

FIG. 33 depicts a block diagram of exemplary internal computer hardware that may be used to contain or implement program instructions used to perform a process, such as the process steps discussed above, according to an embodiment. A bus 700 serves as the main information highway interconnecting the other illustrated components of the hardware. CPU 705 is the central processing unit of the system, performing calculations and logic operations required to execute a program. CPU 705, alone or in conjunction with one or more of the other elements disclosed in FIG. 33, is an exemplary processing device, computing device or processor as such terms are used within this disclosure. Read only memory (ROM) 710 and random access memory (RAM) 715 constitute exemplary memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices. Additionally, the memory devices 725 may be configured to include individual files for storing any feedback information, common files for storing groups of feedback information, or one or more databases for storing the feedback information.

Program instructions, software or interactive modules for providing the interface and performing any querying or analysis associated with one or more data sets may be stored in the ROM 710 and/or the RAM 715. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 730 may permit information from the bus 700 to be displayed on the display 735 in audio, visual, graphic or alphanumeric format. Communication with external devices, such as an optional printing device, may occur using various communication ports 740. An exemplary communication port 740 may be attached to a communications network, such as the Internet or an intranet.

The hardware may also include an interface 745 which allows for receipt of data from input devices such as a keyboard 750 or other input device 755 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A multiport rotary fluid-directing apparatus, comprising:
a first stationary head having a plurality of first ports and a plurality of second ports, wherein each first port of the first stationary head is configured to receive fluid from a fluid source, wherein each second port of the first stationary head is configured to pass fluid to a media vessel;
a first rotating head having a plurality of first ports, a plurality of second ports and a plurality of channels, wherein each channel of the first rotating head fluidly connects a first port of the first rotating head to a corresponding second port of the first rotating head;
a second rotating head having a plurality of first ports, a plurality of second ports and a plurality of channels, wherein each channel of the second rotating head fluidly connects a first port of the second rotating head to a corresponding second port of the second rotating head;
a second stationary head having a plurality of first ports and a plurality of second ports, wherein each first port of the second stationary head is configured to pass fluid to an output, wherein each second port of the second stationary head is configured to receive fluid from a media vessel;
a plurality of media vessels configured to receive fluid from a second port of a first stationary head and transmit fluid to a corresponding second port of a second stationary head; and
a rotating system configured to cause the first rotating head and the second rotating head to rotate, wherein the rotating system comprises a motor and a controller.

2. The apparatus of claim 1 wherein the angular lengths of the first ports and the second ports of the first stationary head are longer than the angular lengths of the first ports and the second ports of the first rotating head.

3. The apparatus of claim 1 wherein the angular lengths of the first ports and the second ports of the first stationary head are approximately three times longer than the angular lengths of the first ports and the second ports of the first rotating head.

4. The apparatus of claim 1 wherein the angular lengths of the first ports and the second ports of the second stationary head are longer than the angular lengths of the first ports and the second ports of the second rotating head.

5. The apparatus of claim 1 wherein the angular lengths of the first ports and the second ports of the first stationary head are approximately three times longer than the angular lengths of the first ports and the second ports of the first rotating head.

6. The apparatus of claim 1 wherein the rotating system is configured to cause the first rotating head and the second rotating head to rotate approximately
$$\frac{180}{num\_of \_ports}$$
degrees at a time, wherein num_of_ports is a number of the plurality of first ports of the first rotating head.

7. The apparatus of claim 1, wherein a number of first ports of the first rotating head, a number of second ports of the first rotating head, a number of first ports of the first stationary head, a number of second ports of the first stationary head, a number of first ports of the second rotating head, a number of second ports of the second rotating head, a number of first ports of the second stationary head and a number of second ports of the second stationary head are the same.

8. A multiport valve apparatus for purifying, treating and separating fluids by directing multiple fluid streams into and out of a fluid-solid contacting apparatus having a plurality of fluid-solid contacting chambers, said multiport valve comprising:
a rotating cylindrical-shaped head having a circular-shaped sealing base, a circular-shaped fastening base with an axis of rotation therethrough the center of said bases and a cylinder side surface connecting said bases, with said bases having a radius, said sealing base having an inner concentric circle with a radius that is substantially less than said sealing base radius and said sealing base having an outer concentric circle with a radius that is greater than said inner circle radius but less than said sealing base radius,
said sealing base further comprising a plurality of first rotating ports centered on the outer concentric circle, spaced radially equidistant from one another and further comprising a plurality of second rotating ports centered on said inner concentric circle also spaced radially equidistant from one another, wherein the plurality of first rotating ports and the plurality of second rotating ports are equal to one another in number and wherein
each first rotating port is connected to its corresponding second rotating port via a transverse channel to provide a rotating flow pair and wherein
each flow pair are connected in the following manner:
starting with any first rotating port and then connecting that first rotating port to the nearest radially adjacent second rotating port via a transverse channel to form the first rotating flow pair, then connecting the next immediately radially adjacent clockwise first rotating port from said starting first rotating port to the nearest immediately radially adjacent counterclockwise second rotating port from said starting second rotating port via a transverse channel to form the second rotating flow pair, and so on until each first rotating port is connected to a second rotating port and wherein the number of rotating flow pairs corresponds to the number of chambers and wherein
upon rotation of said valve, each of said rotating flow pairs can be sequenced to connect to said plurality of fluid-solid contacting chambers to direct fluid streams into and out of said fluid-contacting chambers.

9. The multiport valve of claim 8 wherein each of said rotating ports has a diameter wherein each of said rotating ports further comprises an arcuate obround-shaped recess aligned along the respective inner and outer concentric circles with each recess having a width corresponding to the diameter of each port and having a length such that the space between each equidistant recess from an adjacent recess is approximately less than or equal to the cross-sectional area of each port.

10. The multiport valve of claim 9 wherein each outer rotating port and its corresponding recess are located at a same outer point along the length of its corresponding recess and wherein each inner rotating port and its corresponding recess are located at a same inner point along the length of its corresponding recess.

11. The multiport valve of claim 8 wherein each outer rotating port and a corresponding recess are located at a same outer point along the length of the corresponding recess of the outer rotating port and wherein each inner rotating port and a corresponding recess are located at a same inner point along the length of the corresponding recess of the inner rotating port.

12. A multiport valve apparatus for purifying, treating and separating fluids by directing multiple fluid streams into and out of a fluid-solid contacting apparatus having a plurality of fluid-solid contacting chambers, said multiport valve comprising:
a fixed cylindrical-shaped head having a circular-shaped sealing base, a circular-shaped fastening base with a central axis therethrough the center of said bases and a side surface connecting said bases, with said bases having a radius, said sealing base having an inner concentric circle with a radius that is substantially less than said sealing base radius and said sealing base having an outer concentric circle with a radius that is greater than said inner circle radius but less than said sealing base radius,
said sealing base further comprising a plurality of first fixed ports centered on said outer concentric circle, spaced radially equidistant from one another and a plurality of second fixed ports centered on said inner concentric circle also spaced radially equidistant from one another, wherein the plurality of first fixed ports and second fixed ports are equal to one another in number and wherein
said side surface having a plurality of upper circumferential contact ports, spaced radially equidistant from one another and radially aligned in accordance with the radial alignment of said second fixed ports such that each upper contact port is connected via an internal channel to the radially adjacent second fixed port and wherein
said side surface having a plurality of lower circumferential contact ports, also spaced radially equidistant from one another and also radially aligned in accordance with the radial alignment of said first fixed ports on said sealing base such that each lower contact port on said side surface is connected via an internal channel to the radially adjacent first fixed port on said sealing base and wherein
each connected upper contact port and it corresponding second fixed port provides a first process flow pair, and wherein each connected lower contact port and its corresponding first port provides a second process flow pair, such that the number of first process flow pairs is equal to the number of second process flow pairs and is also equal to number of chambers such that each process flow pair is connected to either a preselected chamber or has a preselected fluid stream in accordance with a predetermined process such that multiple fluid streams are directed into and out of the fluid-solid contacting chambers.

13. The multiport valve of claim 12 wherein each of said fixed ports has a diameter wherein each of said fixed ports further comprises an arcuate obround-shaped recess aligned along the respective inner and outer concentric circles with each recess having a width corresponding to the diameter of each fixed port and having a length such that the space between each equidistant recess from an adjacent recess is approximately less than or equal to the cross-sectional area of each fixed port.

14. The multiport valve of claim 13 wherein each outer fixed port and its corresponding recess are located at a same outer point along the length of its corresponding recess and wherein each inner fixed port and its corresponding recess are located at a same inner point along the length of its corresponding recess.

15. The multiport valve of claim 12 wherein each outer fixed port and a corresponding recess are located at a same outer point along the length of the corresponding recess of the outer fixed port and wherein each inner fixed port and a corresponding recess are located at a same inner point along the length of the corresponding recess of the inner fixed port.

16. A multiport valve apparatus for purifying, treating and separating fluids by directing multiple fluid streams into and out of a fluid-solid contacting apparatus having a plurality of fluid-solid contacting chambers, said multiport valve comprising:
a rotating cylindrical-shaped head having a circular-shaped sealing base, a circular-shaped fastening base with an axis of rotation therethrough the center of said bases and a cylinder side surface connecting said bases, with said bases having a radius, said sealing base having an inner concentric circle with a radius that is substantially less than said sealing base radius and said sealing base having an outer concentric circle with a radius that is greater than said inner circle radius but less than said sealing base radius,
said sealing base further comprising a plurality of first rotating ports centered on the outer concentric circle, spaced radially equidistant from one another and further comprising a plurality of second rotating ports centered on said inner concentric circle also spaced radially equidistant from one another, wherein the plurality of first rotating ports and the plurality of second rotating ports are equal to one another in number and wherein
each first rotating port is connected to its corresponding second rotating port via a transverse channel to provide a rotating flow pair and wherein
each flow pair are connected in the following manner:
starting with any first rotating port and then connecting that first rotating port to the nearest radially adjacent second rotating port via a transverse channel to form the first rotating flow pair, then connecting the next immediately radially adjacent clockwise first rotating port from said starting first rotating port to the nearest immediately radially adjacent counterclockwise second rotating port from said starting second rotating port via a transverse channel to form the second rotating flow pair, and so on until each first rotating port is connected to a second rotating port and wherein the number of rotating flow pairs corresponds to the number of chambers and wherein
upon rotation of said valve, each of said rotating flow pairs can be sequenced to connect to said plurality of fluid-solid contacting chambers to direct fluid streams into and out of said fluid-contacting chambers;
a fixed cylindrical-shaped head having a circular-shaped sealing base, a circular-shaped fastening base with a central axis therethrough the center of said bases and a side surface connecting said bases, with said bases having a radius, said sealing base having an inner concentric circle with a radius that is substantially less than said sealing base radius and said sealing base having an outer concentric circle with a radius that is greater than said inner circle radius but less than said sealing base radius,
said sealing base further comprising a plurality of first fixed ports centered on said outer concentric circle, spaced radially equidistant from one another and a plurality of second fixed ports centered on said inner concentric circle also spaced radially equidistant from one another, wherein the plurality of first fixed ports and second fixed ports are equal to one another in number and wherein
said side surface having a plurality of upper circumferential contact ports, spaced radially equidistant from one another and radially aligned in accordance with the radial alignment of said second fixed ports such that each upper contact port is connected via an internal channel to the radially adjacent second fixed port and wherein
said side surface having a plurality of lower circumferential contact ports, also spaced radially equidistant from one another and also radially aligned in accordance with the radial alignment of said first fixed ports on said sealing base such that each lower contact port on said side surface is connected via an internal channel to the radially adjacent first fixed port on said sealing base and wherein
each connected upper contact port and it corresponding second fixed port provides a first process flow pair, and wherein each connected lower contact port and its corresponding first port provides a second process flow pair, such that the number of first process flow pairs is equal to the number of second process flow pairs and is also equal to number of chambers such that each process flow pair is connected to a either a preselected chamber or has a preselected fluid stream in accordance with a predetermined process such that multiple fluid streams are directed into and out of the fluid-solid contacting chambers;
sealing means attached to said fastening base of said fixed head and the fastening base of said rotating head such that the respective sealing bases are urged against one another and aligning said bases such that the central axis of said fixed base is coincident with the rotation axis of said rotational base and such that the plurality of first fixed ports lines up with plurality of first rotating ports and such that the plurality of second fixed ports lines up with the plurality of second rotating ports; and
drive means for rotating and indexing said rotating head on its axis of rotation so that fluid streams flowing through said multiport valve to the chambers can be directed into and out of the fluid-solid contacting chambers.

17. The multiport valve of claim 16 further comprising a second fixed head and a second rotational head such that each rotational head is adjacent to one another and aligned such that their respective axis of rotation are coincident with one another and such that each rotating head is indexed in concert with one another so that proper fluid flows are maintained.

18. The multiport valve of claim 16 wherein each of said rotating ports has a diameter wherein each of said rotating ports further comprises an arcuate obround-shaped recess aligned along the respective inner and outer concentric circles with each recess having a width corresponding to the diameter of each rotating port and having a length such that the space between each equidistant recess from an adjacent recess is approximately less than or equal to the cross-sectional area of each rotating port.

19. The multiport valve of claim 18 wherein each outer rotating port and its corresponding recess are located at a same outer point along the length of its corresponding recess and wherein each inner rotating port and its corresponding recess are located at a same inner point along the length of its corresponding recess.

20. The multiport valve of claim 16 wherein each outer rotating port and a corresponding recess are located at a same outer point along the length of the corresponding recess of the outer rotating port and wherein each inner rotating port and a corresponding recess are located at a same inner point along the length of the corresponding recess of the inner rotating port.

21. The multiport valve of claim 16 wherein each of said fixed ports has a diameter wherein each of said fixed ports further comprises an arcuate obround-shaped recess aligned along the respective inner and outer concentric circles with each recess having a width corresponding to the diameter of each fixed port and having a length such that the space between each equidistant recess from an adjacent recess is approximately less than or equal to the cross-sectional area of each fixed port.

22. The multiport valve of claim 21 wherein each outer fixed port and its corresponding recess are located at a same outer point along the length of its corresponding recess and wherein each inner fixed port and its corresponding recess are located at a same inner point along the length of its corresponding recess.

23. The multiport valve of claim 16 wherein each outer fixed port and a corresponding recess are located at a same outer point along the length of the corresponding recess of the outer fixed port and wherein each inner fixed port and a corresponding recess are located at a same inner point along the length of the corresponding recess of the inner fixed port.
